(19) United States
(12) Patent Application Publication
(10) Pub. No.: US 2018/0371138 A1
(43) Pub. Date: Dec. 27, 2018

(54) AQUEOUS SYNTHESIS AND IN-SITU RAPID SCREENING OF AMPHIPHILIC POLYMERS

(71) Applicants: UNIVERSIDADE DE SANTIAGO DE COMPOSTELA, A Coruña (ES); UNIVERSITY OF BIRMINGHAM, West Midlands (GB)

(72) Inventors: Javier MONTENEGRO GARCIA, A Coruña (ES); Francisco FERNANDEZ-TRILLO, West Midlands (GB)

(73) Assignees: UNIVERSIDADE DE SANTIAGO DE COMPOSTELA, A Coruña (ES); UNIVERSITY OF BIRMINGHAM, West Midlands (GB)

(21) Appl. No.: 16/062,536

(22) PCT Filed: Dec. 14, 2016
(86) PCT No.: PCT/EP2016/081085

§ 371 Date: Jun. 14, 2018

(30) Foreign Application Priority Data
Dec. 17, 2015 (ES) P201531831

(51) Int. Cl. C08F 220/60; C08F 220/34

(52) U.S. Cl. CPC C08F 220/60; C08F 8/28; C08F 220/34

(57) ABSTRACT

The present invention refers to a novel screening method for transfection employing novel acryloyl based amphiphilic polymers.

### FIELD OF THE INVENTION

The present invention relates to screening methods that use novel amphiphilic polymers conjugated with biomolecules such as DNA, RNA or siRNA. The novel methods allow a faster and more flexible screening of suitable transfecting agents and delivering biomolecules of interest. The application also discloses novel transfecting agents identified following the screening method.

### Background of the Invention

The pharmaceutical industry is always in the search of ever more efficient screening methods. One of the main challenges faced by the industry in the latest years is providing compositions or devices capable of overcoming the cell membrane barrier and deliver the active pharmaceutical ingredient to the target cell. This issue is critical in the case of gene therapy, where relatively large molecules being charged, and thus lipophobic, such as nucleic acids (DNA, RNA or siRNA), have to overcome the lipophilic cell membrane. For many years, researchers have been searching for amphiphilic molecules which can conjugate with such hydrophobic molecules and at the same time pass through the cell membranes.

Early success was obtained with positively charged lipid molecules, such as those described in WO 94/05624 (Invitrogen). Each lipid has to be separately synthesized and then screened, and are thus not suitable for high-throughput screening. Recently, the group of Siegwart has reported a method for the preparation of libraries of lipocationic polyesters via ring-opening polymerization of valerolactones. The high efficiency of the polymerization conditions allowed the direct screening of the resulting polymers for siRNA delivery. However, the polymerization requires the use of specialized equipment such as a glove box to avoid the presence of moisture, detrimental for the polymerization process. Also, the resulting polymers have to be combined with several additives such as (PEG lipids, Cholesterol and DSCP lipids) in order to obtain efficient delivery vehicles. Hao, Jing, Petra Kos, Kejin Zhou, Jason B Miller, Lian Xue, Yunfeng Yan, Hu Xiong, Sussana Elkassih, and Daniel J Siegwart. “Rapid Synthesis of a Lipocationic Polyester Library via Ring-Opening Polymerization of Functional Valerolactones for Efficacious siRNA Delivery.” J. Am. Chem. Soc. 2015, 137, 9206-9209.

In fact, to the best of our knowledge there are no examples in the public domain of technologies for the synthesis and in-situ screening of single component polymeric gene vectors. Anderson et al. (e.g. U.S. Pat. No. 8,557,231, U.S. Pat. No. 8,287,849, U.S. Pat. No. 7,427,394 or J. J. Green, G. T. Zugates, N. C. Tedford, Y. H. Huang, L. G. Griffith, D. A. Lauffenburger, J. A. Sawicki, R. Langer, D. G. Anderson, Adv. Mater. 2007, 19, 2836-2842) have developed a remarkable body of research based on amphiphiles generated by the condensation of diacrylates and amines. Polymer length and molecular weight distribution of the products obtained are however intrinsically different, as each polymer stems from a “unique” polymerization, making difficult a systematic screening and the identification of structure-activity relationships. Organic solvents are used, so no in-situ screening is possible.

Klibanov et al. (M. Thomas, J. J. Lu, C. Zhang, J. Chen, A. M. Klibanov, Pharm. Res. 2007, 24, 1564-1571) applied a similar strategy but using PEI (polyethylenimine). Again no in-situ screening is possible since organic solvents are used and polymers need to be purified before conjugation and screening. Yu et al. (L. Gan, J. L. Olson, C. W. Ragsdale, L. Yu, Chem. Commun. 2008, 573-575; T. Potta, Z. Zhen, T. S. P. Grandhi, M. D. Christensen, J. Ramos, C. M. Breneman, K. Rege, Biomaterials 2014, 35, 1977-1988) use divinylsulfonamides instead of acrylates. Again, organic solvents are used and polymers need to be purified. Rege et al. (S. Barua, A. Joshi, A. Banerjee, D. Matthews, S. T. Sharfstein, S. M. Cramer, R. S. Kane, K. Rege, Mol. Pharmaceutics 2008, 6, 86-97) use diepoxides instead of acrylates. A pseudo in-situ screening is possible since neat starting materials are used, which are then diluted into the buffer used for polyplex formation. The molecular weight of the products obtained is however difficult to control and each polymer stems from a “unique” polymerization, making difficult a systematic screening and the identification of structure-activity relationships. Also solubility cannot be easily tuned, and the compounds are synthesized first and then checked for solubility. In Merkel et al. (V. Nadithe, R. Liu, B. A. Killinger, S. Movassaghian, N. H. Kim, A. B. Moszczynska, K. S. Masters, S. H. Gellman, O. M. Merkel, Mol. Pharmaceutics 2015, 12, 362-374) a library is prepared by co-polymerization of protected functional monomers. Even though polymers with similar molecular weight can be synthesized (e.g. entry P G2A and G3) the number of monomer units are intrinsically different, depending on the efficiency of the polymerization of each monomer. Polymerisations are done using protected monomers and organic solvents, requiring again deprotection and purification. Schubert et al. (WO2015/048940) prepared poly(alkene) polymers, which are then functionalized with thiols. Poly(alkene)'s solubility under aqueous conditions is limited, compromising potential for in-situ screening. Functionalisation is done in MeOH, which is toxic.

Bertozzi R., C. et al. (K. Godula, C. R. Bertozzi, J. Am. Chem. Soc. 2010, 132, 9963-9965) disclose poly(acryoyl hydrazides) of 174 units, which are however conjugated with reducing sugars (hydrophilic) and thus not appropriate for transfection. Also, the synthesis requires generation of the hydrazide moiety using hydrazine, which is a toxic and explosive reagent.

Dynamic hydrazone amphiphilic small molecules for transfection are disclosed in Matile et al. (C. Gehin, J. Montenegro, E.-K. Bang, A. Cajaraville, S. Takayama, H. Hirose, S. Futaki, S. Matile, H. Riezman, J. Am. Chem. Soc. 2013, 135, 9295-9298). Matile's strategy is to fix the cationic fragment to the scaffold and screen different hydrophobic modulators in small molecules. This system is limited thus in the amount of cationic residues that it can incorporate, (two cationic charges and four hydrophobic tails in the disclosed examples) which is fundamental to increase the stability of the conjugates with polyanionic biomolecules such as DNA, RNA and XNA (Niidome, T., Takaji, K., Urakawa, M., Ohmori, N., Wada, A., Hirayama, T., and Aoyagi, H. “Chain length of cationic R-helical peptide sufficient for gene delivery into cells” Bioconjugate Chem. 1999, 10, 773-780; Ward, C. M., Read, M. L. and Seymour, L. W “Systemic circulation of poly(L-lysine)/DNA vectors is influenced by polycation molecular weight and type of DNA: differential circulation in mice and rats and the implications for human gene therapy” Blood, 2001, 97, 2221-2229).

There is thus a need to provide flexible and more efficient methods for screening suitable multivalent polymers for transfection of cells with active pharmaceutical ingredients.

### BRIEF DESCRIPTION OF THE INVENTION

The inventors have solved the problems of previous screening methods for new polymers with potential in transfection of nucleic acids by providing a novel polymeric scaffold and the realization that such scaffold can be easily functionalized with readily available lipophilic and cationic moieties to provide amphiphilic polymers. The provision of said amphiphilic polymers (and their precursors) and screening methods will significantly improve the current situation as discussed below.

Thus, a first aspect of the invention is polymer of formula (I), salts and stereoisomers thereof,

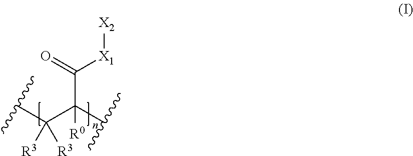

wherein
n is the average number of monomer units and is a number equal to or greater than 10;
R⁰ is selected from the group consisting of hydrogen, a C₁-C₃ alkyl group and CN, for example, wherein R⁰ is hydrogen or methyl
each R³ is independently selected from the group consisting of hydrogen and a C₁-C₃ alkyl group;
X₁ is a group selected from the group consisting of —N(H)—, —O—, —N(H)-Alkyl- and —O-Alkyl-;
X₂ is independently selected in each unit from the group consisting of —NH₂, —N═C(H)R¹ and —N═C(H)R²; wherein R¹ is a lipophilic moiety and R² is a cationic moiety; and
   wherein the percentage of lipophilic moieties present in the polymer with respect to the total number of X₂ groups is comprised between 1 and 99%;
   wherein the percentage of cationic moieties present in the polymer with respect to the total number of X₂ groups is comprised between 1 and 99%; and
   wherein the sum of the percentage of lipophilic moieties and of the cationic moieties is comprised between 2 and 100%.

The inventors have confirmed that these polymers are surprisingly efficient in the transfection of active pharmaceutical ingredients that would be otherwise incapable of overcoming the lipid bilayer membrane. Such active pharmaceutical ingredients are namely negatively charged compound, such as large polymeric biomolecules (e.g. DNA, RNA or siRNA).

A further aspect of the invention is thus a composition comprising the polymer, salts and stereoisomers thereof, of formula (I), and a negatively charged compound.

Due to the amphiphilic nature of the polymer of formula (I), the above composition can be easily prepared and directly used in screening assays. It is therefore another aspect of the invention a screening method comprising the step of putting in contact the above composition and a lipophilic membrane. The consistency of the amphiphilic polymeric conjugates was validated by the reproducibility of the all the transfection experiments.

The polymer of formula (I) and the composition resulting from its association with negatively charged molecules (e.g. nucleic acids or polynucleotides) can be used in the preparation of medicaments (or pharmaceutical compositions), and further aspects of the invention are thus:
The polymer of formula (I), salts and stereoisomers thereof, for use as a medicament.
The polymer of formula (I), salts and stereoisomers thereof, for use in the transfection of cells.
The composition for use as a medicament.
The composition for use in the transfection of cells.
Pharmaceutical compositions comprising the composition of the invention

The inventors have devised a method and reagents that allow the preparation of amphiphilic polymeric molecules suitable for transfection. All steps can be performed in aqueous media. From an easily and reliably prepared novel polymeric scaffold it is possible to introduce a vast diversity of lipophilic and cationic moieties to modulate the properties of the resulting amphiphilic polymer and, without further purifications, mix it with an active pharmaceutical ingredient of interest, and test in situ the transfecting properties of the resulting composition. It is also possible to shelf stock solutions of the different intermediates in order to use them at any time. The result is of an unprecedented flexibility and efficiency in the screening of transfecting molecules, and new methods and precursors.

Further aspects of the invention are thus the precursors of the polymer of formula (I) and synthetic methods thereof.

Accordingly, a further aspect of the invention is a process for the preparation of the polymer of formula (I), salts and stereoisomers thereof, comprising the step of putting in contact a polymer of formula (II), salts and stereoisomers thereof

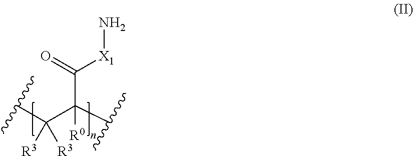

with an aldehyde of formula O═C(H)R¹ and an aldehyde of formula O═C(H)R²;
wherein n, X₁, R⁰, R¹, R² and R³ are as defined above.

A further aspect of the invention is a polymer of formula (II), salts and stereoisomers thereof

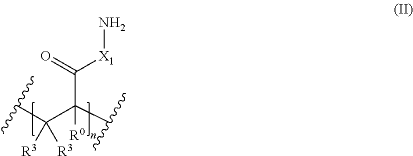

wherein
n is the average number of monomer units that is a number between 10 and 150;
R⁰ is selected from the group consisting of hydrogen, a C₁-C₃ alkyl group and CN, for example, wherein R⁰ is hydrogen or methyl
each R³ is independently selected from the group consisting of hydrogen and a C₁-C₃ alkyl group; and
X₁ is a group selected from the group consisting of —N(H)—, —O—, —N(H)-Alkyl- and —O-Alkyl-.

A further aspect of the invention is a process for the preparation of the polymer of formula (II), salts and stereoisomers thereof, comprising the step of putting in contact a polymer of formula (III), salts and stereoisomers thereof, with acid media

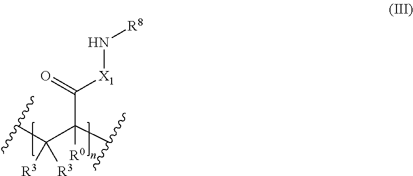

wherein n, X₁, R⁰ and R³ are as defined above; and
R⁸ is a group labile in acid media.

A further aspect of the invention is thus a polymer of formula (III), salts and stereoisomers thereof

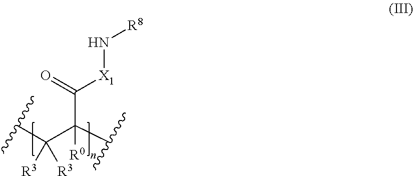

wherein
   n is the average number of monomer units that is a number equal to or greater than 10;
   R⁰ is selected from the group consisting of hydrogen, a C₁-C₃ alkyl group and CN, for example, wherein R⁰ is hydrogen or methyl
   each R³ is independently selected from the group consisting of hydrogen and a C₁-C₃ alkyl group;
   X₁ is a group selected from the group consisting of —N(H)—, —O—, —N(H)-Alkyl- and —O-Alkyl-; and
   R⁸ is a group labile in acid media.

A further aspect of the invention is a process for the preparation of a polymer of formula (III), salts and stereoisomers thereof, comprising polymerizing a compound of formula (IV), salts and stereoisomers thereof, preferably, in the presence of a radical initiator

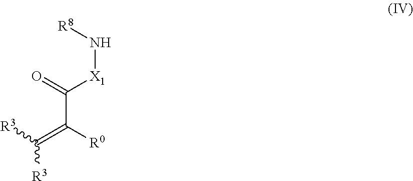

wherein
   X₁ is a group selected from the group consisting of —N(H)—, —O—, —N(H)-Alkyl- and —O-Alkyl-;
   R⁰ is selected from the group consisting of hydrogen, a C₁-C₃ alkyl group and CN, for example, wherein R⁰ is hydrogen or methyl
   each R³ is independently selected from the group consisting of hydrogen and a C₁-C₃ alkyl group; and
   R⁸ is a group labile in acid media.

A further aspect of the invention is a compound of formula (IV), salts and stereoisomers thereof,

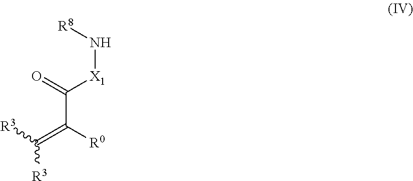

wherein
X₁ is a group selected from the group consisting of —N(H)—, —O—, —N(H)-Alkyl- and —O-Alkyl-;
R⁰ is selected from the group consisting of hydrogen, a C₁-C₃ alkyl group and CN, for example, wherein R⁰ is hydrogen or methyl
each R³ is independently selected from the group consisting of hydrogen and a C₁-C₃ alkyl group; and
R⁸ is a group labile in acid media.

A further aspect of the invention is a process for the preparation of a compound of formula (IV), salts and stereoisomers thereof, comprising the step of putting in contact a compound of formula (V), salts and stereoisomers thereof, with an —R₈ protecting group or with a compound of formula —N(H₂)—N(H)—R₈, —O—N(H)—R₈, —N(H₂)-Alkyl-N(H)—R₈ and —O-Alkyl-N(H)—R₈

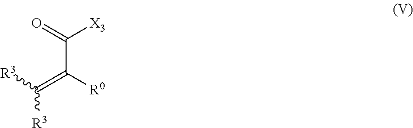

wherein
R⁰ is selected from the group consisting of hydrogen, a C₁-C₃ alkyl group and CN, for example, wherein R⁰ is hydrogen or methyl;
each R³ is independently selected from the group consisting of hydrogen and a C₁-C₃ alkyl group; and
X₃ is selected from the group consisting of —OH, halogen, O-alkyl, —N(H)—N(H₂), —O—N(H₂), —N(H)-Alkyl-N(H₂) and —O-Alkyl-N(H₂).

The above processes provide surprisingly consistent polymers in terms of molecular weights and size.

Thus the present invention provides amphiphilic molecules with excellent transfection activity by means of a flexible and efficient screening method, where the process, from the polymers of formula (II) to the transfection assays, including the amphiphilic functionalization, and the conjugation and the screening can be done in aqueous media without intermediate purification.

### BRIEF DESCRIPTION OF THE FIGURES

FIG. 1: Changes to fractional emission intensity I(t) (FIG. 1A) and dose-response curve (FIG. 1B) for the transport of DNA Herring (125 μM) in EYPC-LUVs⊃HPTS/DPX with increasing concentrations of amphiphilic polymer prepared from 15% of benzaldehyde and 85% of the Guanidinium aldehyde of example 5 (GA-5) ligands. Concentrations of amphiphilic polymer (AP): 75 μM (◯), 50 μM (□), 37.5 μM (⋄), 25 μM (x), 12.25 μM (+), 6 μM (Δ), 1.5 μM (●), 0.6 μM (▪), 0.06 μM (♦).

FIG. 2: Transfection efficiency in HeLa EGFP at a constant concentration of amphiphilic polymer (12.25 μM, 15% of iso-valeraldehyde and 85% of GA-5 ligands) and increasing concentrations of siEGFP.

FIG. 3: FIG. 3A: Transfection efficiency in HeLa GFI-EGFP at a constant siRNA concentration (14 nM) and increasing concentrations of amphiphilic polymers (e.g. 15% of iso-valeraldehyde and 85% of GA-5 ligands). FIG. 3B: Transfection efficiency in HeLa EGFP at a constant siRNA concentration (14 nM) and fixed concentration of amphiphilic polymers (12.25 μM) prepared from different percentages of iso-valeraldehyde. Percentage of GA-5=100%—iso-valeraldehyde percentage.

FIG. 4: Cell viability from fluorescence decrease and cytotoxicity assay with HeLa-EGFP at constant siRNA concentration (14 nM) and increasing concentrations of amphiphilic polymers (15% of iso-valeraldehyde and 85% of GA-5 ligands) (FIG. 4A), at a fixed concentration of polymeric amphiphile (12.25 μM) and with different percentages of iso-valeraldehyde (Percentage of GA-5=100%—iso-valeraldehyde percentage) (FIG. 4B).

FIG. 5: General screening method. A polymer (1) is mixed with the required amounts of aldehydes (3) of formula O═C(H)R¹ and aldehydes (2) of formula O═C(H)R². The resulting polymer (4) is then conjugated with a negatively charged compound (5), such as DNA, RNA or siRNA. The resulting composition (6) is then submitted for transfection to a membrane or membrane model (7).

### DETAILED DESCRIPTION OF THE INVENTION

### Definitions

Many of the compounds disclosed herein can form salts. For example, the polymers may include nitrogen atoms that can be protonated to form a positive charge, and/or carboxylic acids or thiol moieties that can become deprotonated and have a negative charge, depending on the pH of the media. All such variations are readily available to the skilled person in view of the present disclosure, and are part of the invention. Such salts are preferably pharmaceutically acceptable salts. Non-limiting examples are halides, sulphates; hydrohalide salts; phosphates; lower alkane sulphonates; arylsulphonates; salts of C₁-C₂₀ aliphatic mono-, di- or tribasic acids which may contain one or more double bonds, an aryl nucleus or other functional groups such as hydroxy, amino, or keto; salts of aromatic acids in which the aromatic nuclei may or may not be substituted with groups such as hydroxyl, lower alkoxyl, amino, mono- or di-lower alkylamino sulphonamido. Also included within the scope of the invention are quaternary salts of the tertiary nitrogen atom with lower alkyl halides or sulphates, and oxygenated derivatives of the tertiary nitrogen atom, such as the N-oxides. The compounds of the present invention can also form salts with different inorganic acids or bases, such as hydrochloric acid, phosphoric acid or sodium hydroxide, all included in the scope of the present invention.

An “stereoisomer” in the present disclosure makes reference to compounds made up of the same atoms bonded by the same sequence of bonds but having different three-dimensional structures which are not interchangeable.

“Alkyl” refers to a straight or branched hydrocarbon chain radical consisting of carbon and hydrogen atoms, containing no unsaturation, having the number of carbon atoms indicated in each case, which is attached to the rest of the molecule by a single bond. If no number of carbons is given in a specific case, it is understood that it is an alkyl group having between 1 and 12 carbon atoms, preferably between 1 and 6, preferably between 1 and 3 carbon atoms. Exemplary alkyl groups can be methyl, ethyl, n-propyl, i-propyl, n-butyl, t-butyl, n-pentyl, or even larger, depending on the size required.

“Cycloalkyl” refers to a saturated carbocyclic ring having the number of carbon atoms indicated in each case. Suitable cycloalkyl groups include, but are not limited to cycloalkyl groups such as cyclopropyl, cyclobutyl, cyclopentyl or cyclohexyl.

“Alkenyl” refers to a straight or branched hydrocarbon chain radical consisting of carbon and hydrogen atoms, containing at least one unsaturation, having the number of carbon atoms indicated in each case, and which is attached to the rest of the molecule by a single bond. Exemplary alkenyl groups can be allyl, butenyl (e.g. 1-butenyl, 2-butenyl, 3-butenyl), or pentenyl (e.g. 1-pentenyl, 2-pentenyl, 3-pentenyl, 4-pentenyl).

“Cycloalkenyl” refers to a carbocyclic ring having the number of carbon atoms indicated in each case, and at least one unsaturation. Suitable cycloalkenyl groups include, but are not limited to cycloalkenyl groups such as 1-cyclobutenyl, 2-cyclobutenyl, 1-cyclopentenyl, 2-cyclopentenyl or 3-cyclopentenyl.

“Alkynyl” refers to a straight or branched hydrocarbon chain radical consisting of carbon and hydrogen atoms, containing at least one carbon-carbon triple bond, conjugated or not, having the number of carbon atoms indicated in each case, and which is attached to the rest of the molecule by a single bond, such as —C≡CH, —CH₂C≡CH, —C≡CCH₃, —CH₂C≡CCH₃.

“Cycloalkynyl” refers to a carbocyclic ring having the number of carbon atoms indicated in each case, and at least one triple bond. Suitable cycloalkynyl groups include, but are not limited to cyclooctynyl, cyclononynyl or cyclododecynyl.

“Alkylcarboxyacid” refers to a group having the number of carbon atoms indicated in each case, and comprising (i) an alkyl group attached to the rest of the molecule through a single bond; and (ii) a carboxy group attached to said alkyl group.

“Alkylcarboxyacid derivative” refers to a group having the number of carbon atoms indicated in each case, and comprising (i) an alkyl group attached to the rest of the molecule through a single bond; and (ii) a carboxy derivative selected from esters and amides attached to said alkyl group.

“Aryl” refers to an aromatic hydrocarbon radical having the number of carbon atoms indicated in each case, such as phenyl or naphthyl.

“Aralkyl” refers to an aryl group linked to the rest of the molecule by an alkyl group such as benzyl and phenethyl.

“Heterocyclyl” refers to a stable ring having the number of carbon atoms indicated in each case, which consists of carbon atoms and from one to five heteroatoms selected from the group consisting of nitrogen, oxygen, and sulphur, preferably a 4- to 8-membered ring with one or more heteroatoms, more preferably a 5- or 6-membered ring with one or more heteroatoms. For the purposes of this invention, the heterocycle may be a monocyclic, bicyclic or tricyclic ring system, which may include fused ring systems; and the nitrogen, carbon or sulfur atoms in the heterocyclyl radical may be optionally oxidised; the nitrogen atom may be optionally quaternized; and the heterocyclyl radical may be partially or fully saturated or aromatic. Examples of such heterocycles include, but are not limited to, azepines, benzimidazole, benzothiazole, isothiazole, imidazole, indole, piperidine, piperazine, purine, quinoline, thiadiazole, tetrahydrofuran.

“Heteroaryl” refers to a heterocyclic group wherein at least one of the rings is an aromatic ring.

Any of the above groups can be optionally substituted with 1 to 10 groups selected from halogens, such as fluoro or ether linkages.

Amphiphilic Polymers and Compositions

The polymers of formula (I), as defined previously, are conjugated with aldehydes, namely, positively charged modulator (e.g. GA-5) and different hydrophobic modulators (e.g. iso-valeraldehyde). The resulting amphiphilic polymers are combined with negatively charged biomolecules to afford the compositions of the invention, suitable as transfecting agents and capable of generating a large library of screening candidates in a straight forward method. The inventors have also confirmed that the above mentioned polymers and compositions provide positive results in transfecting different membrane models.

Different variants of the polymers of formula (I), as defined previously, will be readily recognized by the skilled person. For example, a suitable exemplary polymer according to the present disclosure is a polymer of formula (VII), salts and stereoisomers thereof

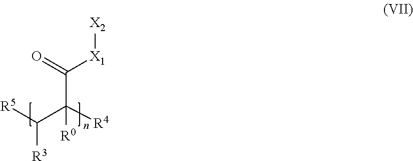

wherein
n is the average number of monomer units that is a number equal to or greater than 10;
R⁰ is selected from the group consisting of hydrogen, a C₁-C₃ alkyl group and CN, for example, wherein R⁰ is hydrogen or methyl
each R³ is independently selected from the group consisting of hydrogen and a C₁-C₃ alkyl group;
R⁴ is selected from the group consisting of —SH, —S-Alkyl, —O-Alkyl, —OH and —NH₂, preferably, —SH, —S-Alkyl, —O-Alkyl;
R⁵ is a C₂-C₁₂ alkylcarboxyacid or a C₂-C₁₂ alkylcarboxyacid derivative;
X₁ is a group selected from the group consisting of —N(H)—, —O—, —N(H)-Alkyl- and —O-Alkyl-, preferably wherein X₁ is —N(H)—;
X₂ is independently selected in each unit from the group consisting of —NH₂, —N═C(H)R¹ and —N═C(H)R²; wherein R¹ is a lipophilic moiety and R² is a cationic moiety; and
   wherein the percentage of lipophilic moieties present in the polymer with respect to the total number of X₂ groups is comprised between 1 and 99%;
   wherein the percentage of cationic moieties present in the polymer with respect to the total number of X₂ groups is comprised between 1 and 99%; and
   wherein the sum of the percentage of lipophilic moieties and of the cationic moieties is comprised between 2 and 100%.

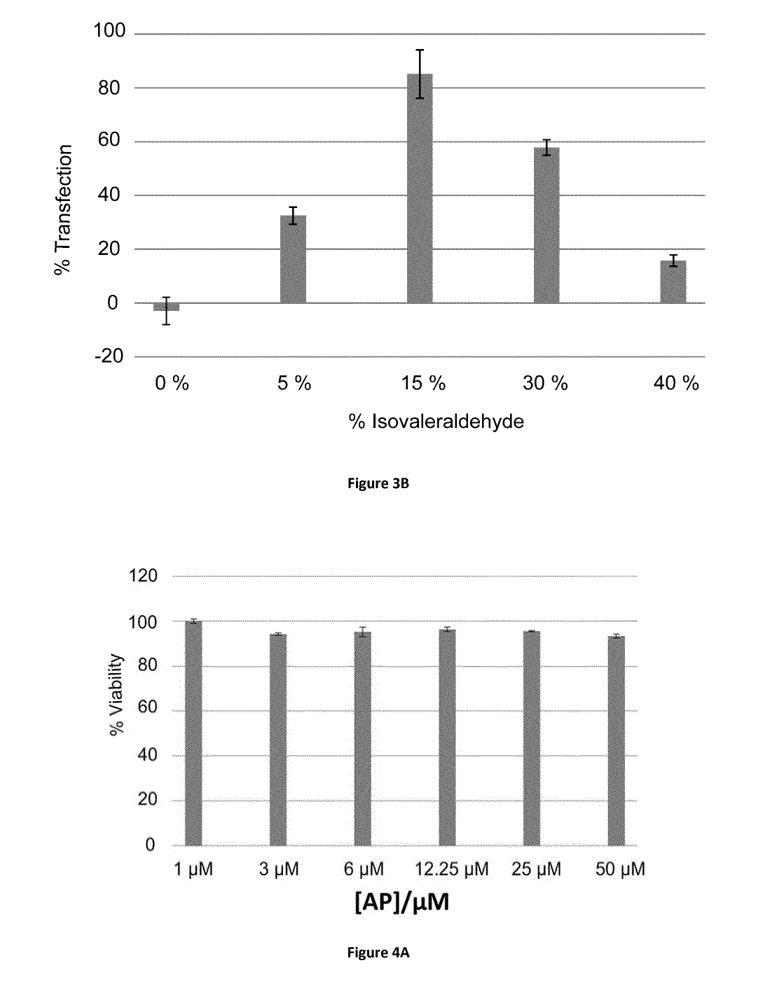

The size of the polymers of the present disclosure is not of particular relevance as long as they maintain their amphiphilic properties. Regarding this issue, the election of the inventors of a polymeric scaffold having multiple available —X₁—X₂ groups for functionalization is an additional advantage. In addition to the flexibility already mentioned, the use of these polymers provides greater functionalization with less synthetic effort and allows the fast identification of efficient transfecting reagents with no toxicity in cell models as showed by the MTT viability test (FIGS. 4A and 4B). Thus, the average number of monomer units n can be a number comprised between 10 and 300, for example equal to or less than 150, such as between 20 and 120, for example between 30 and 100. The term “amphiphilic” in the present disclosure its given the generally accepted meaning for the skilled person, and thus refers to a molecule combining hydrophilic and lipophilic (hydrophobic) properties.

The polymers of the present disclosure are typically based on acryloyl derivatives and therefore generally speaking R⁰ is selected from the group consisting of hydrogen, a C₁-C₃ alkyl group and CN, for example, wherein R⁰ is hydrogen or methyl. R³ is typically for all units hydrogen or methyl, preferably hydrogen. The skilled person can recognize that the methodology described in the present invention can be applied to different (meth)acryloyl derivatives following the same principles.

The polymerization can be a radical polymerization, but other polymerization methods are available to the skilled person. As explained below, the polymerization reaction is typically carried out in the presence of a chain transfer agent (CTA), and thus the polymers of the invention can be terminated at either ends by moieties deriving from such CTAs. Other polymerization methods are possible, and these moieties are not particularly relevant to the function of the composition of the invention and the skilled person can choose from a wide range of commercial CTAs (or any other suitable polymerization methods), for example, derivatives combining an (((ethylthio)carbonothioyl)thio) moiety and a carboxylic acid residue, which would give raise to a polymer of formula (VII) wherein R⁴ is —SH and R⁵ is a C₂-C₁₂ alkylcarboxyacid, for example, having the formula —(R⁶)(R⁷)C—C(═O)OH, wherein R⁶ and R⁷ are each independently selected from a C₁-C₃ alkyl group or hydrogen, preferably wherein R⁶ and R⁷ are both methyl. Further details are given in the synthesis section below.

However, the structure of R₄ and R₅ can vary depending on the polymerization method used and the particular reagents in each case. The use of atom transfer polymerization (ATRP) or nitroxide mediated radical polymerization (NMP) will give raise to polymers having the same units disclosed herein, but with different terminations R₄ and R₅. ATRP usually employs a transition metal complex as the catalyst with an alkyl halide as the initiator, opening the possibility of R₄ being a halogen atom. Other possible mechanisms can be recognized by the skilled person and can be found in reference books such as (1) Matyjaszewski, K., and Möller, M. (Eds.). Polymer Science: A Comprehensive Reference. Elsevier B.V. vol 3 Chain Polymerization of Vinyl Monomers; or (2) Tsarevsky, N. V., and Sumerlin, B. S. (Eds.). (2013) Fundamentals of Controlled/Living Radical Polymerization. Royal Society of Chemistry, Cambridge. Further, the R₄ or R₅ termination can be functionalized so as to include other molecules which can help in the screening, such as chromophores or targeting agents.

The group X₁ bridges the polymeric scaffold and the nitrogen atom to which the lipophilic and cationic moieties will attach. It is preferred that X₁ and X₂ together a (—N(H)—N(H)—) or a (—N(H)—N═) group, as the inventors have discovered that the protected carbazones can be readily reacted with acryloyl monomers and later polymerized and deprotected with ease (see below). Thus, it is preferred in the polymers of the present disclosure that X₁ is —N(H)—. Other polymers wherein X₁ is —O—, —N(H)-Alkyl- or —O-Alkyl- are also suitable and readily available following the synthetic methods shown herein (see below).

One of the key aspects of the polymers and methods of the present disclosure is the possibility of functionalizing the polymeric scaffold with a wide array of lipophilic and cationic residues with unprecedented ease and flexibility. As a result the polymers disclosed herein and the corresponding compositions can include a wide variety of lipophilic moieties and cationic (hydrophilic) moieties.

The term “lipophilic” or “hydrophobic”, as used herein, it's given its normal meaning in the art, and refers to substances that have greater solubility in lipids than in aqueous media. When considering lipophilic moieties in the field of chemistry, the skilled person has at hand a great variety of possibilities to choose from and it is generally understood which substances will impart lipophilicity and which ones will not. Such groups are widely described in the literature, for example in C. Gehin, J. Montenegro, E.-K. Bang, A. Cajaraville, S. Takayama, H. Hirose, S. Futaki, S. Matile, H. Riezman, J. Am. Chem. Soc. 2013, 135, 9295-9298, already discussed in the background. Preferably, the term “lipophilic” refers to moieties which have a log K_{ow} value of greater than 1.0, more preferably a log K_{ow} value greater than 2.0, wherein the log K_{ow} value is measured by the distribution behavior of the moiety in a biphasic system such as in the octanol/water partition test. This test involves the measurement of the equilibrium concentration of a dissolved substance in a two-phase system of an octanol and water as well as a chromatographic method and is described in ASTM E1147.

Generally, lipophilicity will be achieved by organic molecules such as hydrocarbons (e.g. alkyl, alkenyl, aryl and the like). These molecules are generally apolar, although they may contain a relative small amount of polar groups or groups capable of hydrogen bonding. Exemplary R¹ groups are those in which the corresponding aldehyde is readily available (commercial or easy to synthesize). Thus, R¹ can be selected from the group consisting of C₁-C₄₀ alkyl, C₂-C₄₀ alkenyl, C₂-C₄₀ alkynyl, C₃-C₄₀ cycloalkyl, C₄-C₄₀ cycloalkenyl, C₅-C₄₀ cycloalkynyl, C₆-C₄₀ aryl, C₇-C₄₀ alkylaryl, C₃-C₄₀ heterocyclyl and C₅-C₄₀ heteroaryl, optionally substituted with 1 to 10 groups selected from halogens such as fluoro or ether linkages. Preferably, R¹ is selected from the group consisting of C₁-C₁₀ alkyl, C₂-C₁₀ alkenyl, C₂-C₁₀ alkynyl, C₃-C₁₀ cycloalkyl, C₄-C₄₀ cycloalkenyl, C₅-C₁₀ cycloalkynyl, C₇-C₁₅ alkylaryl and C₅-C₁₅ heteroaryl, optionally substituted with 1 to 5 groups selected from halogens such as fluoro or ether linkages. Preferably, R¹ is selected from the group consisting of C₁-C₁₀ alkyl, C₃-C₁₀ cycloalkyl, C₇-C₁₅ alkylaryl and C₅-C₁₅ heteroaryl, optionally substituted with 1 to 5 groups selected from halogens such as fluoro or ether linkages. Exemplary R¹ groups are those which corresponding aldehyde is readily available (commercial or easy to synthesize). Exemplary aryl and alkylaryl groups are phenyl, naphtyl, C₇-C₁₂ alkyl substituted phenyl (e.g. methylphenyl), or biphenyl. Exemplary alkyl and cycloalkyl groups have 3 to 7 carbon atoms and can be cyclopentyl, cyclohexyl, butyl, tert-butyl, propyl, isopropyl, neopentyl, neobutyl (iso-valeryl), pentyl, hexyl. Excellent transfection activity has been achieved when R¹ is selected from the group consisting of branched C₁-C₇ alkyl. Exemplary heteroaryl groups are imidazoyl, furyl or tiophenyl.

R² is a cationic moiety that imparts hydrophilicity to the polymers and compositions of the present disclosure. R² typically comprises a cationic group having a positively charged heteroatom. Such cationic group is positively charged at the pH at which it is exposed for the assay or medical application, typically having a pKa when protonated (pKaH) above 4, or a pKa above 7, i.e. a group that will become protonated at the pH of the medium, e.g. physiological pH. Non-limiting exemplary cationic groups are benzimidazolium (pKaH above about 5.6), imidazolium (pKaH above about 7.0), morpholinium (pKaH above about 8.76), piperazinium (pKaH above about 9.8), azepanium (pKaH above about 11.07), piperidinium (pKaH above about 11.22), pyrrolidinium (pKaH above about 11.27), indolinium (pKaH above about 16.2), ammonium (pKaH above about 9.25), phosphonium (pKaH above about 9) or guanidinium groups (pKaH above about 13), for example, ammonium (pKaH above about 9.25), phosphonium (pKaH above about 9) or guanidinium groups (pKaH above about 13).

The cationic group can be a residue of formula -L-G, wherein L is a linker comprising an organic moiety and G a positively charged group. The specific nature of the linking group L or of G is thus not critical. Simple and commercially available compounds of formula O═C(H)—R² which can be used in the present invention are compounds of formula (IX) O═C(H)—Z-G, wherein Z is a group comprising 1 to 40 carbon atoms, and G is positively charged group. The Z group can be an alkyl group (e.g. C₁-C₂₀-alkyl group), a C₁-C₂₀-cycloalkyl group, containing or not the G group in the ring scaffold, may comprise an aromatic ring or an heterocyclic or an heteroaryl group, containing or not the G group in the ring scaffold, all of which may be optionally substituted. G can be a positively charged ammonium, phosphonium or guanidinium. For example, the compound of formula O═C(H)—R² can be a compound of formula (X) O═C(H)—Y-G, wherein Y is selected from the group consisting of C₁-C₁₂ alkyl, optionally including as part of the alkyl chain between 1 and 3 amide or ester groups, C₆-C₁₆-aryl, C₄-C₁₆-heterocyclyl and C₄-C₁₆-heteroaryl, all optionally substituted, and G is a positively charged ammonium, phosphonium or guanidinium group. Thus, for example, Y can be a —(CH₂)ᵣ— alkyl chain having 1 to 12 carbon atoms (r=1-12) or a phenyl group. Exemplary molecules that can be used as cationic moieties are betaine aldehyde, 4-(trimethylamino)butyraldehyde, 4-(dimethylamino)benzaldehyde, 1-(3-formyl-4-hydroxyphenyl)guanidine hydrochloride (Chemical and Pharmaceutical Bulletin, 2003, vol. 51, #6 p. 625), 1-(4-formylphenyl)guanidine (SU172307), 1-(5-formyl-4-methylthiazol-2-yl)guanidine (U.S. Pat. No. 6,521,643), piperidine-4-carbaldehyde hydrochloride (piperidine-4-carbaldehyde hydrochloride), 1-(4-oxobutyl)guanidine (Biochemical Journal, 2015, vol. 468, #1 p. 109).

A further example of a R² group is a moiety of formula (XI)

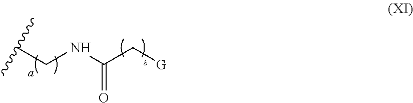

wherein a is number between 1 and 6, i.e. 1, 2, 3, 4, 5 or 6, for example between 1 and 3; b is a number between 1 and 6, i.e. 1, 2, 3, 4, 5 or 6, for example between 1 and 3; and G is a positively charged ammonium, phosphonium or guanidinium.

Ammonium groups are typically of the formula —N⁺H₃, but other possibilities can be recognized by the skilled person, such as a group of formula (XII)

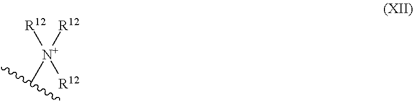

wherein each R¹² group is independently selected from the group consisting of C₁-C₆ alkyl, C₂-C₆ alkenyl, C₂-C₆ alkynyl, C₃-C₆ cycloalkyl, C₄-C₆ cycloalkenyl, C₅-C₇ cycloalkynyl, C₆-C₈ aryl, C₇-C₁₀ alkylaryl, C₃-C₁₀ heterocyclyl and C₅-C₁₀ heteroaryl.

Guanidinium groups are typically of the formula —[N(H)—C(NH₂)═NH₂]⁺, but other possibilities can be recognized by the skilled person, such as a group of formula (XIII)

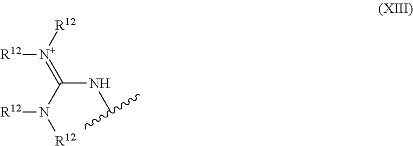

wherein each R¹² group is independently selected from the group consisting of C₁-C₆ alkyl, C₂-C₆ alkenyl, C₂-C₆ alkynyl, C₃-C₆ cycloalkyl, C₄-C₆ cycloalkenyl, C₅-C₇ cycloalkynyl, C₆-C₈ aryl, C₇-C₁₀ alkylaryl, C₃-C₁₀ heterocyclyl and C₅-C₁₀ heteroaryl.

Phosphonium groups are typically of the formula —P⁺H₃, but other possibilities can be recognized by the skilled person, such as a group of formula (XIV)

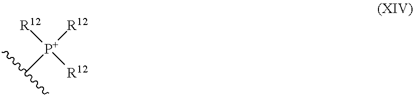

wherein each R¹² group is independently selected from the group consisting of C₁-C₆ alkyl, C₂-C₆ alkenyl, C₂-C₆ alkynyl, C₃-C₆ cycloalkyl, C₄-C₆ cycloalkenyl, C₅-C₇ cycloalkynyl, C₆-C₈ aryl, C₇-C₁₀ alkylaryl, C₃-C₁₀ heterocyclyl and C₅-C₁₀ heteroaryl.

The corresponding aldehydes carrying a moiety of formula (XI), wherein b is between 1 and 4 are to the best of our knowledge new. Thus a further aspect of the invention is a compound of formula O═C(H)—R¹¹, wherein R¹¹ is a moiety of formula (XI)

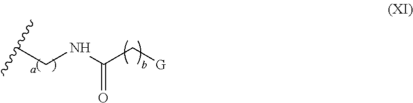

wherein a is number between 1 and 6; b is a number between 1 and 4; and G is a positively charged ammonium, phosphonium or guanidinium.

The polymers of the invention allow an extraordinarily flexible screening, and the amphiphilicity of the polymers and compositions can be modulated by the nature of the lipophilic and cationic moieties, as well as by the proportion of each of them. Thus, the percentage of lipophilic moieties present in the polymer with respect to the total number of X₂ groups can be comprised between 5 and 70%, preferably between 7 and 60%, preferably between 7 and 20%, more preferably between 10 and 20%. Also, it can be readily understood that different mixtures of cationic moieties can be made and thus provide a polymer of formula (I) wherein more than one type of cationic molecule has been incorporated. Also, it can be readily understood that different mixtures of lipophilic moieties can be made and thus provide a polymer of formula (I) wherein more than one type of lipophilic molecule has been incorporated. The percentage of cationic moieties present in the polymer with respect to the total number of X₂ groups can be comprised between 10 and 99%, preferably between 40 and 95%, preferably between 60 and 90%, more preferably between 65 and 85%. At the same time, the sum of the percentage of lipophilic moieties and of the cationic moieties can be comprised between 40 and 80%. The percentage of lipophilic moieties R¹ (% of R¹) is a hundred times the result of dividing the average number of R¹ groups (number of R¹) between the average total number of X₂ positions available (X₂ positions), i.e. % of R¹=100×(number of R¹)/(X₂ positions). The percentage of lipophilic moieties R² (% of R²) is a hundred times the result of dividing the average number of R² groups (number of R²) between the average total number of X₂ positions available (X₂ positions), i.e. % of R²=100×(number of R²)/(X₂ positions).

In view of the above and the specific examples provided, the skilled person can devise different combinations of the above parameters and substituents, all of which are encompassed in the present disclosure. For example, the polymer of the invention can be a polymer of the formula (VIIa), salts and stereoisomers thereof

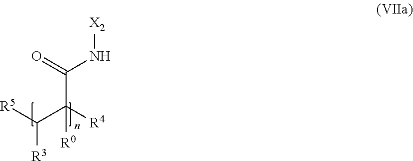

wherein
n is the average number of monomer units that is a number comprised between 10 and 70;
R⁰ is selected from the group consisting of hydrogen, a C₁-C₃ alkyl group and CN, for example, wherein R⁰ is hydrogen or methyl
R³ is hydrogen or methyl;
R⁴ is selected from the group consisting of —SH, —S-Alkyl, —O-Alkyl, —OH and —NH₂, preferably, —SH, —S-Alkyl, —O-Alkyl;
R⁵ is a C₂-C₁₂ alkylcarboxyacid or a C₂-C₁₂ alkylcarboxyacid derivative;
X₂ is independently selected in each unit from the group consisting of —NH₂, —N═C(H)R¹ and —
N═C(H)R²; wherein R¹ is a lipophilic moiety and R² is a cationic moiety; and
   wherein the percentage of lipophilic moieties present in the polymer with respect to the total number of X₂ groups is comprised between 5 and 30%;
   wherein the percentage of cationic moieties present in the polymer with respect to the total number of X₂ groups is comprised between 60 and 90%; and
   wherein the sum of the percentage of lipophilic moieties and of the cationic moieties is comprised between 5 and 95%.

A further example, can be a polymer of the formula (VIIb), salts and stereoisomers thereof

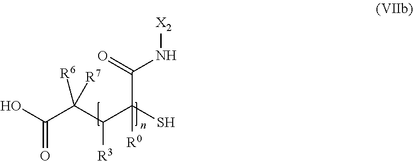

wherein
n is the average number of monomer units that is a number comprised between 10 and 70;
R⁰ is selected from the group consisting of hydrogen, a C₁-C₃ alkyl group and CN, for example, wherein R⁰ is hydrogen or methyl
R³ is hydrogen or methyl;
R⁶ and R⁷ are independently selected from hydrogen and a C₁-C₃ alkyl;
X₂ is independently selected in each unit from the group consisting of —NH₂, —N═C(H)R¹ and —N═C(H)R²; wherein R¹ is a lipophilic moiety and R² is a cationic moiety; and
   wherein the percentage of lipophilic moieties present in the polymer with respect to the total number of X₂ groups is comprised between 5 and 30%;
   wherein the percentage of cationic moieties present in the polymer with respect to the total number of X₂ groups is comprised between 60 and 90%; and
   wherein the sum of the percentage of lipophilic moieties and of the cationic moieties is comprised between 5 and 95%.

Preparation of the Polymers

The polymers and compositions herein disclosed can be synthesized from readily available materials.

The synthesis starts with the preparation of the appropriate monomers of formula (IV), salts and stereoisomers thereof,

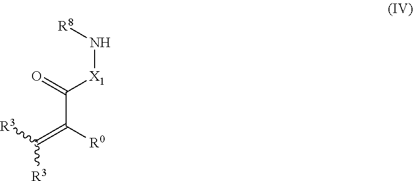

wherein
X₁ is a group selected from the group consisting of —N(H)—, —O—, —N(H)-Alkyl- and —O-Alkyl-, preferably —N(H)—;
R⁰ is selected from the group consisting of hydrogen, a C₁-C₃ alkyl group and CN, for example, wherein R⁰ is hydrogen or methyl
each R³ is independently selected from the group consisting of hydrogen and a C₁-C₃ alkyl group; and
R⁸ is a group labile in acid media.

comprising the step of putting in contact a compound of formula (V), salts and stereoisomers thereof, with an —R₈ protecting group, preferably labile in acid media, or with a compound of formula —N(H₂)—N(H)—R₈, —O—N(H)—R₈, —N(H)-Alkyl-N(H)—R₈ and —O-Alkyl-N(H)—R₈

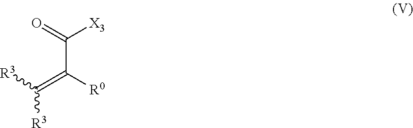

wherein
R⁰ is selected from the group consisting of hydrogen, a C₁-C₃ alkyl group and CN, for example, wherein R⁰ is hydrogen or methyl;
each R³ is independently selected from the group consisting of hydrogen and a C₁-C₃ alkyl group; and
X₃ is selected from the group consisting of —OH, halogen, O-alkyl, —N(H)—N(H₂), —O—N(H₂), —N(H)-Alkyl-N(H₂) and —O-Alkyl-N(H₂).

The reaction typically takes place in the presence of an appropriate solvent, preferably an aqueous based solvent, and a suitable base. The compounds of formula —N(H₂)—N(H)—R₈ are carbazate reagents. Different carbazate reagents are available to the skilled person, for example t-butyl carbazate, benzyl carbazate, ethyl carbazate, methyl carbazate or mixtures thereof. The compounds of formula-O—N(H)—R₈ are protected hydroxyl amines, many of which are commercially available, such as N-Boc-hydroxylamine or N-(Benzyloxycarbonyl)hydroxylamine. In order to make those compounds of formula (IV) wherein X₁ is —N(H)-Alkyl- or —O-Alkyl-, the skilled person can react a compound of formula (V) wherein X₃ is —OH, halogen or —OR, with a compound of formula —N(H₂)-Alkyl-N(H)—R₈ or —O-Alkyl-N(H)—R₈. Alternatively, it is possible to directly protect with the —R₈ protecting group a compound of formula (V) wherein X₃ is —N(H)-Alkyl-N(H₂) or —O-Alkyl-N(H₂); such compounds of formula (V) are commercially available, for example 2-Aminoethyl methacrylate hydrochloride or N-(3-Aminopropyl)methacrylamide hydrochloride (available from Aldrich®).

Since the residue R⁸ acts as an amino protecting group during polymerization, it is designed to be labile, preferably under acidic conditions, in order to cleave it once the polymerization is complete. “Protecting group” in the present invention refers to a group that blocks an organic functional group and can be removed under controlled conditions. Protecting groups, their relative reactivities and conditions under which they remain inert are known to the skilled person. “Amino protecting group” refers to a group that blocks the —NH₂ or —N(H)—NH₂ function for further reactions and can be removed under controlled conditions. The amino protecting groups are well known in the art, representative protecting groups are
amides of formula —C(═O)R⁹, such as acetate amide, benzoate amide; pivalate amide; methoxyacetate amide; chloroacetate amide; levulinate amide;
carbamates of formula —C(═O)—O—R⁹, such as benzyl carbamate, p-nitrobenzyl carbamate, tert-butyl carbamate, ethyl carbamate, 2,2,2-trichloroethyl carbamate, 2-(trimethylsilyl)ethyl carbamate.

In all the above formulas R⁹ represents a group selected from the group consisting of C₁-C₆ alkyl, C₆-C₁₅ aryl or aralkyl. Carbamates of formula —(O═)C—O—R⁹, wherein R⁹ is a C₁-C₁₂ alkyl group are preferred. Additional examples of amino protecting groups can be found in reference books such as Greene and Wuts' “Protective Groups in Organic Synthesis”, John Wiley & Sons, Inc., New York, 4^{th} Ed., 2007.

The next step in the synthesis is the preparation of the corresponding polymer of formula (III), salts and stereoisomers thereof by polymerizing a compound of formula (IV), preferably, in the presence of a radical initiator stereoisomers

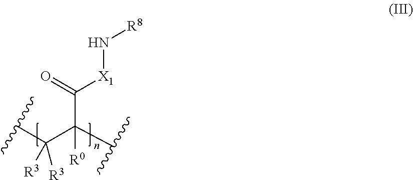

wherein
n is the average number of monomer units that is a number equal to or greater than 10;
R⁰ is selected from the group consisting of hydrogen, a C₁-C₃ alkyl group and CN, for example, wherein R⁰ is hydrogen or methyl
each R³ is independently selected from the group consisting of hydrogen and a C₁-C₃ alkyl group;
X₁ is a group selected from the group consisting of —N(H)—, —O—, —N(H)-Alkyl- and —O-Alkyl-; and
R⁸ is a protecting group, preferably labile in acid media.

Polymerization typically takes place in aqueous media. When using a radical polymerization different radical initiators are available in the art and include both peroxide compounds and azo compounds. Examples of suitable free radical initiators are peroxide catalysts like dibenzoyl peroxide, lauroyl peroxide, t-amylperoxy-2-ethylhexanoate, di-t-butyl peroxide, diisopropyl peroxide carbonate, t-butyl peroxy-2-ethylhexanoate, t-butylperpivalate, t-butylperneo-decanoate, t-butylperbenzoate, t-butyl percrotonate, t-butyl perisobutyrate, t-butylperoxy-1-methylpropanoate, t-butylperoxy-2-ethylpentanoate, t-butylperoxyoctanoate and di-t-butylperphthalate. Examples of azo compounds are azobis-isobutyronitrile (AIBN), 4,4′-azobis(4-cyanovaleric acid) (ACVA) and azobis-(2-methylbutanenitrile). The quantity of initiator may range from 0.01 percent by weight to 5 percent by weight based on total weight of monomer(s).

Polymerization typically takes place in the presence of Chain Transfer Agent (CTA), also known as reversible addition fragmentation chain transfer (RAFT) agent, which are known to the skilled person. Non-limiting examples are those disclosed in US2015024488 or in US2012128743. The CTA can be a compound of formula (XV) or salts thereof

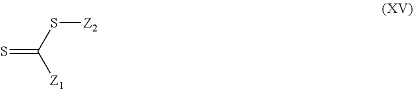

Wherein Z₁ is a hydrophobic group and Z₂ is a hydrophilic group. This group of CTAs is widely known in the art and explained, for example, in US2012128743. Preferably, Z₁ is a thiol such as an R¹⁰—S— group, wherein R¹⁰ is a C₁-C₂₀ alkyl, C₁-C₂₀ aryl or a C₁-C₂₀ arylalkyl, preferably one such that the moiety Z₁—C(═S)— is labile under acidic conditions in order to be cleaved at the same time as the R⁸ group. Preferably, Z₂ is a C₂-C₁₂ alkylcarboxyacid or a C₂-C₁₂ alkylcarboxyacid derivative, such as -alkyl-CO₂H, -alkyl-C(═O)(NH₂), -alkyl-SO₃. The CTA is preferably 2-(((ethylthio)carbonothioyl)thio)-2-methylpropanoic acid.

The skilled person can recognize that any other method for the polymerization of (meth)acryloyl derivatives is suitable for the purposes of the present invention as long as the reaction results in the formation of polymers of formula (III). Other methods for polymerizing (meth)acryloyl derivatives include but are not limited to Atom-transfer Radical Polymerization (ATRP), Nitroxide-mediated Polymerization (NMP), Degenerative Transfer with Alkyl Iodide, Cobalt-Catalyzed Chain Transfer Polymerization, organometallic mediated radical polymerization (OMRP), Anionic Polymerization, Cationic Polymerization, Metallocene Alkene Polymerization or Living Transition Metal-Catalyzed Alkene Polymerization. Additional examples of polymerization methods can be found in reference books such as Matyjaszewski, K., and Möller, M. (Eds.). Polymer Science: A Comprehensive Reference. Elsevier B.V.

Thus, a preferred polymer of formula (III) is a compound of formula (IIIa), salts and stereoisomers thereof

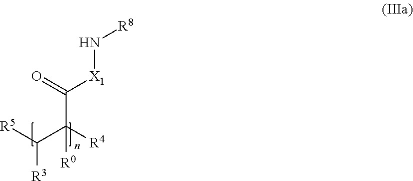

wherein
   n is the average number of monomer units that is a number equal to or greater than 10;
   R⁰ is selected from the group consisting of hydrogen, a C₁-C₃ alkyl group and CN, for example, wherein R⁰ is hydrogen or methyl
   R³ is selected from the group consisting of hydrogen and a C₁-C₃ alkyl group;
   R⁴ is selected from the group consisting of —SH, —S-Alkyl, —O-Alkyl, —OH and —NH₂, preferably, —SH, —S-Alkyl, —O-Alkyl;
   R⁵ is a C₂-C₁₂ alkylcarboxyacid or a C₂-C₁₂ alkylcarboxyacid derivative;
   X₁ is a group selected from the group consisting of —N(H)—, —O—, —N(H)-Alkyl- and —O-Alkyl-, preferably —N(H)—; and
   R⁸ is a group labile in acid media.

Further examples of the chain transfer agents include mercapto compounds, such as thioglycolic acid, thiomalic acid, thiosalicylic acid, 2-mercaptopropionic acid, 3-mercaptopropionic acid, 3-mercaptobutyric acid, N-(2-mercaptopropionyl)glycine, 2-mercaptonicotinic acid, 3-[N-(2-mercaptoethyl)carbamoyl]propionic acid, 3-[N-(2-mercaptoethyl)amino]propionic acid, N-(3-mercaptopropionyl)alanine, 2-mercaptoethanesulfonic acid, 3-mercaptopropanesulfonic acid, 4-mercaptobutanesulfonic acid, dodecyl (4-methylthio)phenyl ether, 2-mercaptoethanol, 3-mercapto-1,2-propanediol, 1-mercapto-2-propanol, 3-mercapto-2-butanol, mercaptophenol, 2-mercaptoethylamine, 2-mercaptoimidazole, 2-mercapto-3-pyridinol, 2-mercaptobenzothiazole, mercaptoacetic acid, trimethylolpropane tris(3-mercaptopropionate), and pentaerythritol tetrakis(3-mercaptopropionate); disulfide compounds obtained by oxidizing the recited mercapto compounds; and iodized alkyl compounds, such as iodoacetic acid, iodopropionic acid, 2-iodoethanol, 2-iodoethanesulfonic acid, and 3-iodopropanesulfonic acid.

Once the protected polymer is obtained, deprotection takes place under acidic conditions in order to provide the corresponding polymer of formula (II), salts and stereoisomers thereof

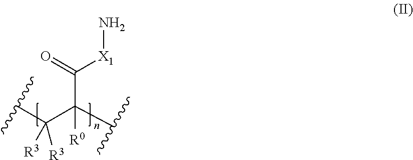

wherein
n is the average number of monomer units that is a number between 10 and 150;
R⁰ is selected from the group consisting of hydrogen, a C₁-C₃ alkyl group and CN, for example, wherein R⁰ is hydrogen or methyl
each R³ is independently selected from the group consisting of hydrogen and a C₁-C₃ alkyl group; and
X₁ is a group selected from the group consisting of —N(H)—, —O—, —N(H)-Alkyl- and —O-Alkyl-, preferably —N(H)—.

A preferred polymer of formula (II) is a polymer of formula (IIa), salts and stereoisomers thereof

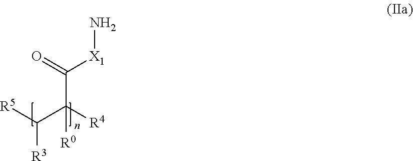

wherein
   n is the average number of monomer units that is a number between 10 and 150;
   R⁰ is selected from the group consisting of hydrogen, a C₁-C₃ alkyl group and CN, for example, wherein R⁰ is hydrogen or methyl
   R³ is selected from the group consisting of hydrogen and a C₁-C₃ alkyl group;
   R⁴ is selected from the group consisting of —SH, —S-Alkyl, —O-Alkyl, —OH and —NH₂, preferably, —SH, —S-Alkyl, —O-Alkyl;
   R⁵ is a C₂-C₁₂ alkylcarboxyacid or a C₂-C₁₂ alkylcarboxyacid derivative; and
   X₁ is a group selected from the group consisting of —N(H)—, —O—, —N(H)-Alkyl- and —O-Alkyl-, preferably —N(H)—.

The final step of the preparation of the polymers of formula (I) is the functionalization of the available nitrogen atoms with the aldehydes of the corresponding R¹ (lipophilic) and R² (cationic) groups, i.e. with aldehydes of formula O═C(H)—R¹ and O═C(H)—R², wherein R¹ and R² are as defined elsewhere in the present disclosure. The reaction comprises contacting the aldehydes of formula O═C(H)—R¹ and O═C(H)—R² with the polymer (II) in an appropriate media, preferably aqueous media, and proceeds smoothly. Both aldehydes of formula O═C(H)—R¹ and O═C(H)—R² can be simultaneously or sequentially contacted with the polymer. As already discussed, the method allows to easily change the proportion or the total amount in which both aldehydes are incorporated to the polymer. The equivalents added are not particularly relevant and the invention works for a broad range of aldehyde loadings. The skilled person can determine which amounts and proportions are best suited for each particular case and typical conditions are those wherein said aldehyde of formula O═C(H)R¹ and said aldehyde of formula O═C(H)R² are added in amounts, for example, comprised between 0.001 and 10 equivalents with respect to the total amount NH₂ moieties available, for example between 0.01 and 4 or between 0.01 and 3, typically between 0.1 and 2.5 equivalents.

Screening Methods

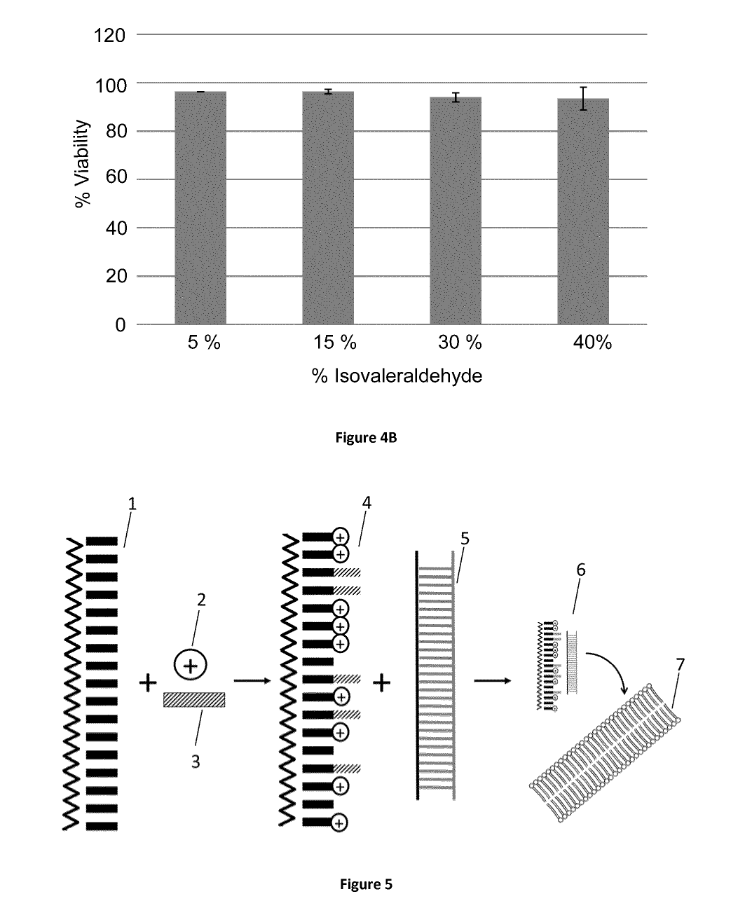

The general screening method of the present disclosure is shown in FIG. 5. A polymer (1) of formula (II), salts and stereoisomers thereof, is mixed with chosen amounts of said aldehydes (3) of formula O═C(H)R¹ and said aldehydes (2) of formula O═C(H)R², in order to provide a polymer (4) of formula (I), salts and stereoisomers thereof, which are then conjugated with a negatively charged compound (5), typically a nucleic acid, such as DNA, RNA or siRNA. The resulting composition (6) is then submitted for transfection to a cell, membrane or membrane model (7).

Preferably, a polymer (1) of formula (IIa), salts and stereoisomers thereof, is mixed with chosen amounts of said aldehydes (3) of formula O═C(H)R¹ and said aldehydes (2) of formula O═C(H)R², in order to provide a polymer (4) of formula (VII), salts and stereoisomers thereof, which are then conjugated with a negatively charged compound (5), typically a nucleic acid, such as DNA, RNA or siRNA. The resulting composition (6) is then submitted for transfection to a membrane or membrane model (7).

Further exemplary nucleic acids are possible and can comprise, for example, one or more of plasmid DNA (pDNA), cosmids, double-stranded RNA (dsRNA), small interfering RNA interference (siRNA), endogenous microRNA (miRNA), short hairpin RNA (shRNA), oligodeoxynucleotides (ODN), primary RNA transcripts (pri-miRNA). These and others are described in the literature, such as (1) Deng, Y., Wang, C. C., Choy, K. W., Du, Q., Chen, J., Wang, Q., Li, L., Chung, T. K. H., and Tang, T. (2014) “Therapeutic potentials of gene silencing by RNA interference: Principles, challenges, and new strategies” Gene 538, 217-227; (2) Li, Z., and Rana, T. M. (2014) “Therapeutic targeting of microRNAs: current status and future challenges” Nat. Rev. Drug Discovery 13, 622-638; or (3) Alexander, C., and Fernandez-Trillo, F. (2013) “Bioresponsive Polyplexes and Micelleplexes, in Smart Materials for Drug Delivery” (Alvarez-Lorenzo, C., and Concheiro, A., Eds.) 1st ed., pp 256-282. Royal Society of Chemistry.

Artificial nucleic acids such as XNAs or PNAs can also be used. Examples thereof can be found in (1) Turner, J. J., Jones, S., Fabani, M. M., Ivanova, G., Arzumanov, A. A., and Gait, M. J. (2007) “RNA targeting with peptide conjugates of oligonucleotides, siRNA and PNA” Blood Cells Mol. Dis. 38, 1-7); (2) Pinheiro, V. B., and Holliger, P. (2012) “The XNA world: progress towards replication and evolution of synthetic genetic polymers” Curr. Opin. Chem. Biol. 16, 245-252; (3) Pinheiro, V. B., and Holliger, P. (2014) “Towards XNA nanotechnology: new materials from synthetic genetic polymers” Trends Biotechnol. 32, 321-328.

One of the key advantages of the present screening method is that all steps from polymer (1) to the transfection assay of compound (6) can be performed in aqueous media without purifying any of the intermediates. For example, stock solutions of a polymer of formula (II), salts and stereoisomers thereof, can be made, and later mixed with different aldehydes in parallel and/or automatized experiments, each resulting polymer conjugated with a molecule of interest being negatively charged, and the resulting composition submitted to transfection.

Thus, a further aspect of the present invention is a kit comprising a polymer of formula (II), salts and stereoisomers thereof.

A further aspect of the present invention is a kit comprising a polymer of formula (I), salts and stereoisomers thereof.

A further aspect of the present invention is a kit comprising the composition of the invention comprising a polymer of formula (I), salts and stereoisomers thereof and a negatively charged molecule.

The compositions resulting from the screening method of the invention can thus be used as medicaments, specifically in the delivery of biologically active molecules having a negative charge which would otherwise be incapable of trespassing the lipidic membrane. The present invention thus includes pharmaceutical composition comprising the compositions of the invention and pharmaceutically acceptable carriers and/or other auxiliary substances.

The medicament or pharmaceutical compositions according to the present invention may be in any form suitable for the application to humans and/or animals, preferably humans including infants, children and adults and can be produced by standard procedures known to those skilled in the art. The medicament can be produced by standard procedures known to those skilled in the art, e.g. from the table of contents of “Pharmaceutics: The Science of Dosage Forms”, Second Edition, Aulton, M. E. (ED. Churchill Livingstone, Edinburgh (2002); “Encyclopedia of Pharmaceutical Technology”, Second Edition, Swarbrick, J. and Boylan J. C. (Eds.), Marcel Dekker, Inc. New York (2002); “Modern Pharmaceutics”, Fourth Edition, Banker G. S. and Rhodes C. T. (Eds.) Marcel Dekker, Inc. New York 2002 y “The Theory and Practice of Industrial Pharmacy”, Lachman L., Lieberman H. And Kanig J. (Eds.), Lea & Febiger, Philadelphia (1986). The composition of the medicament may vary depending on the route of administration, and it usually comprises mixing the compositions of the invention with appropriate carriers and/or other auxiliary substances. The carriers and auxiliary substances necessary to manufacture the desired pharmaceutical form of administration of the pharmaceutical composition of the invention will depend, among other factors, on the elected administration pharmaceutical form. Said pharmaceutical forms of administration of the pharmaceutical composition will be manufactured according to conventional methods known by the skilled person in the art. A review of different active ingredient administration methods, excipients to be used and processes for producing them can be found in “Tratado de Farmacia Galénica”, C. Faulí i Trillo, Luzán 5, S.A. de Ediciones, 1993.

Non-limiting examples are preparations for oral administration, i.e. tablets, capsules, syrups or suspensions. Also, the pharmaceutical compositions of the invention may include topical compositions, i.e. creams, ointments or pastes, or transdermic preparations such as patches or plasters.

The term “pharmaceutically acceptable” refers to molecular entities and compositions that are physiologically tolerable and do not typically produce an allergic or similar untoward reaction, such as gastric upset, dizziness and the like, when administered to a human. Preferably, as used herein, the term “pharmaceutically acceptable” means approved by a regulatory agency of the Federal or a state government or listed in the U.S. Pharmacopeia or other generally recognized pharmacopeia for use in animals, and more particularly in humans.

### EXAMPLES

### Example 1: Materials and Methods

Nuclear Magnetic Resonance (NMR) spectra were recorded on a Bruker Avance III 300 MHz, Bruker Avance III 400 MHz spectrometer, Varian Mercury 300 MHz or a Varian Inova 500 MHz spectrometer. Chemical shifts are reported in ppm (6 units) referenced to the following solvent signals: DMSO-d6 δH 2.50, D2O δH 4.79 and CDCl3, δH 7.26. The average degree of polymerization (DP) (i.e. the ratio between monomer units and end-groups) in polymers of formula (II) was calculated by 1H-NMR spectra by comparing the integration of the methyl substituents in the end-group (0.95 and 1.01 ppm, 6H) to the integration from the aliphatic region in the polymer backbone (1.59-2.08 ppm). Electrospray ionization mass spectrometry (ESI-MS) for the characterization of new compounds was performed on a Finnigan MAT SSQ 7000 instrument or an ESI API 150EX and are reported as mass-per-charge ratio m/z (intensity in %, [assignment]). Accurate mass determinations (HR-MS) using ESI-MS were performed on a Sciex QSTAR Pulsar mass spectrometer. Infrared (IR) spectra were recorded on a Perkin Elmer Spectrum Two FT-IR spectrometer. Ultraviolet-visible (UV-vis) spectra were recorded on a Campsec M550 Double Beam Scanning UV-vis Spectrophotometer. DP in polymer of formula (III) was calculated by measuring the absorbance at 300, 305 and 310 nm and comparing against a calibration curve using CTA. The amount (mg·mL⁻¹) of CTA in polymers of formula (III) was obtained this way and the DP calculated. Fluorescence measurements were performed with a FluoroMax-2 spectrofluorometer (Jobin-Yvon Spex) equipped with a stirrer and a temperature controller. Size Exclusion Chromatography (SEC) spectra were recorded on a Shimadzu Prominence LC-20A fitted with a Thermo Fisher Refractomax 521. Polymers of formula (III) were analysed using 0.05 M LiBr in DMF at 60° C. as the eluent and a flow rate of 1 mL·min⁻¹. The instrument was fitted with a Polymer Labs PolarGel guard column (50×7.5 mm, 5 μm) followed by two PLGel PL1110-6540 columns (300×7.5 mm, 5 μm). Molecular weights were calculated based on a standard calibration method using polymethylmethacrylate (see (1) Pasch, H. Chromatography, in Polymer Science: A Comprehensive Reference (Matyjaszewski, K., and Möller, M., Eds.), pp 33-64. Elsevier B.V.). For analytical HPLC we employ a C18 reverse-phase HPLC column [Nucleosil 100-7 C18, H2O (0.1% TFA)/CH3CN (0.1% TFA) 95:5 (0→5 min), 100:0→25:75 (5→35 min), 0:100 (>35 min)] with a binary gradient of Solvent A and Solvent B, the collected fractions were lyophilized and stored at −20° C.

2-(((ethylthio)carbonothioyl)thio)-2-methylpropanoic acid (CTA) (J. Skey, R. K. O'Reily, Chem. Commun. 2008, 4183) was synthesised according to protocols described in the literature. 8-Hydroxypyrene-1,3,6-trisulfonic acid trisodium salt (HPTS) was purchased from Sigma-Aldrich® and p-xylene-bis-pyridinium bromide (DPX) was purchased from Invitrogen™. Egg yolk L-α-phosphatidylcholine (EYPC) was purchased from Avanti Polar Lipids, Inc. All other chemicals were purchased from Sigma-Aldrich®, Scharlau, Panreac Quimica SLU, Fisher Scientific® or Acros® and used without further purification. All solvents were HPLC grade, purchased from Sigma-Aldrich® or Fisher Scientific®, and used without further purification.

### Example 2: Synthesis of Tert-Butyl-2-Acryloylhydrazine-1-Carboxylate Monomer (Compound of Formula (IV))

Acrylic acid (3.81 mL, 54.95 mmol) and tert-butyl carbazate (8.89 g, 65.95 mmol) were dissolved in a H₂O/THF mixture (2:1, 180 mL) at rt. N-(3-dimethylaminopropyl)-N′-ethylcarbodiimide hydrochloride (EDC) (11.75 g, 61.29 mmol) was added in portions to the solution over 15 minutes and left stirring for 3 h. The crude reaction was extracted with EtOAc (3×75 mL) and the organic layer was washed with 0.1 M HCl (3×75 mL), H₂O (50 mL) and brine (2×50 mL). The organic phase was dried with anhydrous Na₂SO₄ and the solvent was removed under reduced pressure to afford the crude product as a white solid. The crude product was purified by recrystallization from EtOAc (70° C. to rt) to afford a 5.05 g of a white crystalline powder (50%). R_{f}=0.87 (100% EtOAc); IR (neat) vₘₐₓ 3311m sh (N—H), 3221m sh (N—H), 2981w sh (C—H), 1715s sh (C═O), 1668s sh (C═O) cm⁻¹. ¹H-NMR (300 MHz, DMSO-d6) δ (ppm) 9.79 (s, 1H, C⁴(O)NH), 8.84 (s, 1H, C³(O)NH), 6.17-6.20 (m, 2H, CHCH₂), 5.69 (dd, ³J_{H,H}=7.8, 4.5 Hz, 1H, CH₂CH), 1.40 (s, 9H, C(CH₃)₃. ¹³C-NMR (100 MHz, DMSO-d6) δ (ppm) 164.3 (C⁴), 155.3 (C³), 129.4 (C⁵), 126.2 (C⁶), 79.2 (C²), 28.1 (C¹).

### Example 3: Synthesis of Poly(Tert-Butyl-2-Acryloyl)Hydrazine-1-Carboxylate A Polymer Precursor (Polymer of Formula (III))

A solution of 4,4′-azobis(4-cyanovaleric acid) (ACVA) (18.4 mg, 0.064 mmol) in DMSO (1.5 mL) and a solution of CTA (72.3 mg, 0.322 mmol; 2-(((ethylthio)carbonothioyl)thio)-2-methylpropanoic acid) in DMSO (1.5 mL) were added sequentially to a solution of tert-butyl-2-acryloylhydrazine-1-carboxylate (3.00 g, 16.095 mmol) in DMSO (14.88 mL). A 50 μL aliquot of this solution was taken at this stage to aid in the calculation of conversion. The reaction mixture was then sealed and degassed with Argon for 30 min. The degassed solution was left to react at 70° C. for 7 h. The reaction was stopped by allowing it to cool down to room temperature and by exposing it to air. A 50 μL aliquot of this solution was taken at this stage to aid in the calculation of conversion. The polymer was purified by dialysis against water. The water was removed by lyophilisation and by drying in a desiccator with P₂O₅ to afford 2.2 g poly(tert-butyl-2-acryloyl)hydrazine-1-carboxylate A (a polymer of formula (III)) as an off-white powder (73% yield). UV (DMSO) λₘₐₓ 300 nm. 1H-NMR (300 MHz, DMSO-d6) δ (ppm) 9.22 (br, 1H, NH), 8.60 (br, 1H, NH), 2.03 (br, 1H, CH₂CH), 1.41 (br, 11H, 9H in C(CH₃)₃, 2H in CHCH₂). Conversion 40%. Number average molar mass Mn 10270, molar-mass dispersity Ð_{M} 1.39 (as defined in Pure Appl. Chem. 2009, Vol. 81, No. 2, pp. 351-353). DP (UV-vis) 45.

### Example 4: Synthesis of a Reactive Polymeric Scaffold—Synthesis of Poly(Acrylohydrazide) (Polymer of Formula (II))

Trifluoroacetic acid (TFA) (15 mL) was added dropwise to the poly(tert-butyl-2-acryloyl)hydrazine-1-carboxylate) A (1.5 g) (a polymer of formula (III)) obtained in Example 3 and the yellow solution was stirred at rt for 2 h. Excess of TFA was removed by blowing a steady stream of Argon and the resulting oil was diluted in water (15 mL). The polymer.TFA salt formed was neutralised by adding NaHCO₃ until no foaming was observed. The colorless solution was allowed to stir overnight. The crude polymer was purified by dialysis against water. The water was removed by lyophilisation and by drying in a desiccator with P₂O₅ to afford 650 mg of poly(acrylohydrazide) B (a polymer of formula (II)) as a white powder (92%). IR (neat) vₘₐₓ 3254w br (N—H), 1609m br (C═O), 1428s sh cm⁻¹. ¹H-NMR (300 MHz, D₂O) δ (ppm) 1.59-2.08 (br, (3×DP)H, CHCH₂), 1.01 (s, 3H, HOOCCH₃^{b}), 0.95 (s, 3H, HOOCCH₃ₐ). ¹³C-NMR (100 MHz, D₂O) δ (ppm) 174.9 (CONH), 40.2-40.5 (CH), 34.4-35.7 (CH₂). Degree of polymerization (¹H-NMR) 40.

### Example 5: Synthesis of 3-guanidino-N-(3-oxopropyl)propanamide (GA-5) (an Aldehyde of Formula O═C(H)—R¹)

A solution of 3-(2,3-bis(tert-butoxycarbonyl)guanidino)propanoic acid (520 mg, 1.57 mmoles) in dichloromethane (30 mL) was treated with N,N,N′,N′-Tetramethyl-O-(benzotriazol-1-yl)uronium tetrafluoroborate (TBTU) (519.67 mg, 1.57 mmoles), 2-(1,3-dioxolan-2-yl)ethanamine (316 μl, 2.83 mmoles) and N,N-Diisopropylethylamine (DIPEA) (1 mL, 6.28 mmoles, added dropwise). The reaction mixture was stirred at rt under Argon atmosphere for 1 hour. The reaction crude was washed with aqueous HCl (5%, 3×20 mL) and aqueous saturated NaHCO₃ (2×20 mL). The organic layer was dried with anhydrous Na₂SO₄, filtered and concentrated under vacuum. The residue was purified by flash chromatography (gradient MeOH/DCM 1-10%, R_{f}=0.76) to give 542.6 mg of 2-(1,3-dioxolan-2-yl)ethyl-3-(2,3-bis(tert-butoxycarbonyl)guanidino)propanamide (80%). ¹H-NMR (300 MHz, CDCl₃) δ (ppm) 11.4 (s, 1H), 8.7 (t, ³J_{H,H}=4.9 Hz, 1H), 6.66-6.57 (m, 1H), 4.8 (td, ³J_{H,H}=4.3, 0.7 Hz, 1H), 3.95-3.91 (2H, m), 3.85-3.81 (2H, m), 3.70-3.59 (2H, m), 3.4-3.3 (2H, m), 2.41 (t, ³J_{H,H}=6.2 Hz, 2H, m), 1.86-1.84 (2H, m), 1.4 (18H, s). ¹³C-NMR (500 MHz, CDCl₃) δ (ppm) 170.79 (s), 163.40 (s), 156.25 (s), 152.84 (s), 103.89 (d), 83.09 (s), 79.28 (s), 64.89 (t), 36.05 (t), 35.40 (t), 34.71 (t), 32.80 (t), 28.28 (q). ESI-MS (H₂O/CH₃CN) m/z 431 (100, [M+H]⁺), 453 (20, [M+Na]⁺).

A solution of 2-(1,3-dioxolan-2-yl)ethyl-3-(2,3-bis(tert-butoxycarbonyl)guanidino)propanamide (0.69 mmoles, 300 mg) in water was treated with an aqueous solution of HCl (3M, 10 mL). The reaction mixture was stirred at 60° C. for 1 hour. Then the solvent was evaporated under vacuum. The reaction crude was dissolved in H₂O and purified by RP-HPLC. The collected fractions (t_{R} 4.0 min) were lyophilized and stored at −20° C. to give 90 mg of 3-guanidino-N-(3-oxopropyl)propanamide (GA-5) (70%). RP-HPLC [Nucleosil 100-7 C18 H₂O (0.1% TFA)/CH₃CN (0.1% TFA) 100:0→75:35 (10→35 min), 0:100 (>35 min)]. Purity and characterization were confirmed by analytical RP-HPLC, ¹H-NMR and ESI-MS. ¹H-NMR (300 MHz, D₂O) δ (ppm) 9.53 (s, 1H), 5.00-4.77 (m, 1H), 3.40-3.25 (m, 2H), 3.24-3.04 (m, 2H), 2.65-2.60 (m, 2H), 2.52-2.29 (m, 2H), 1.94-1.73 (m, 1H), 1.66 (dd, ³J_{H,H}=12.7, 6.9 Hz, 2H). ESI-MS (H₂O/CH₃CN) m/z 187 (100, [M+H]⁺, 205 (30, [M+H₂O]⁺). HR-MS (MS): Calcd for C₇H₁₅N₄O₂: 187.1185; found: 187.1190.

### Example 6: General Conditions for the Synthesis of Amphiphilic Polymers

In a typical experiment, 25 μl of a solution of a polymer of formula (II) (100 mM) in acetate buffer (100 mM, pH 4.5), 3.8 μl of a solution of hydrophobic aldehyde (200 mM) of formula O═C(H)—R² in dry DMSO and 21.2 μl of a solution of hydrophilic aldehyde (200 mM) of formula O═C(H)—R¹ in dry DMSO were mixed to give a final amphiphilic polymer concentration of 50 mM. This mixture was shaken at 60° C. for 2 h.

### Example 7: Specific Examples of Synthesis of Amphiphilic Polymers

Poly(acrylohydrazide) (B) in acetate buffer (100 mM, pH 3.0) was reacted with 2 equivalents of different molar fractions of GA-5 and different lipophilic aldehydes of formula O═C(H)—R¹. In a typical experiment with mixture of modulators, 25 μl of a solution of poly(acrylohydrazide) (B) (100 mM) in acetate buffer (100 mM, pH 3.0), 3.8 μl of a solution of hydrophobic aldehyde of formula O═C(H)—R¹ (200 mM) (Table 1) in dry DMSO and 21.2 μl of a solution of GA-5 aldehyde (200 mM) in dry DMSO were mixed to give a final concentration amphiphilic polymers of 50 mM. This mixture was shaken at 60° C. for 2 h. The amphiphilic polymers were used without further purification in the transport vesicle experiments and in HeLa cells transfection experiments.

### Example 8: General conditions for the evaluation of transport across model membranes of nucleic acids—Vesicle Experiments

EYPC-large unilamellar stock solutions (5 μl) were diluted with buffer (10 mM Tris, 107 mM NaCl, pH 7.4), placed in a thermostated fluorescence cuvette (25° C.) and gently stirred (total volume ^{˜}2000 μl; final lipid concentration ^{˜}13 μM). HPTS efflux was monitored at λ 511 nm (λₑₓ 413 nm) as a function of time after addition of amphiphilic polymer (20 μl in DMSO/AcOH buffer, t=25 s), nucleic acid (NA, 20 μl stock solution in buffer, t=50 s) and aqueous triton X-100 (1.2%, 40 μl, 370 μM final concentration, t=225 s). Total experiment time=250 s. Fluorescence intensities were normalized to fractional emission intensity I(t) using Equation S1.

I(t)=(Iₜ−I₀)/(I_{∞}−I₀) Equation S1:

where I₀=Iₜ at nucleic acid addition, I_{∞}=Iₜ at saturation after lysis. Effective concentration for amphiphilic polymer or nucleic acid—EC₅₀—and Hill coefficient—n—were determined by plotting the fractional activity Y (=I(t) at saturation just before lysis, t=200 s) as a function of the AMPHIPHILIC POLYMER or nucleic acid concentration [Analyte] and fitting them to the Hill equation (Equation S2).

$$Y = {Y}_{0} + ( {Y}_{max} - {Y}_{0} ) \text{/} \{ 1 + {( \frac{{EC}_{50}}{[ Analyte ]} )}^{n} \} \qquad Equation S2$$

where Y₀ is Y without nucleic acid (or AMPHIPHILIC POLYMER), Yₘₐₓ is Y with an excess of amphiphilic polymer (or nucleic acid) at saturation, EC₅₀ is the concentration of nucleic acid (or amphiphilic polymer) required to reach 50% activity and n is the Hill coefficient. The results are shown in table 1.

TABLE 1

| | Aldehyde | EC₅₀ (μM) | Yₘₐₓ (%) | n |
|---|---|---|---|---|
| 1 | 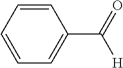 | 12.54 ± 2.25 | 56.00 ± 5.04 | 2.94 ± 1.51 |
| 2 | 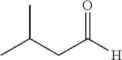 | 17.27 ± 6.88 | 35.72 ± 7.73 | 1.50 ± 0.63 |
| 3 | 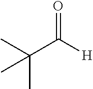 | 8.38 ± 0.53 | 23.12 ± 1.31 | 4.82 ± 1.34 |
| 4 | 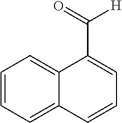 [SMILES: O=Cc1cccc2ccccc12] | 2.40 ± 0.20 | 53.58 ± 3.32 | 3.71 ± 1.02 |
| 5 | 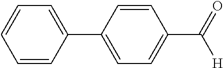 [SMILES: O=Cc1ccc(-c2ccccc2)cc1] | 1.32 ± 0.16 | 50.9 ± 2.60 | 2.88 ± 0.96 |
| 6 | 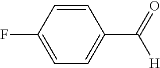 | 3.49 ± 0.19 | 48.48 ± 1.90 | 5.28 ± 1.42 |
| 7 | 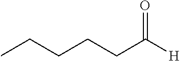 | 9.17 ± 7.60 | 28.34 ± 9.07 | 1.02 ± 0.57 |
| 8 | 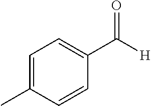 | 2.97 ± 0.52 | 26.71 ± 1.51 | 2.36 ± 0.89 |
| 9 | 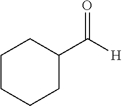 | 9.19 ± 1.97 | 17.84 ± 1.79 | 1.61 ± 0.50 |
| 10 | 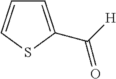 | 2.10 ± 0.51 | 11.51 ± 0.57 | 1.70 ± 0.67 |
| 11 | 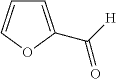 | 16.28 ± 13.17 | 18.27 ± 5.05 | 0.92 ± 0.39 |

EC₅₀ (μM), Y_{MAX} (%) and n for the transport of DNA Herring (125 μM) in EYPC-LUVs⊃HPTS/DPX with increasing concentrations of amphiphilic polymer prepared from 15% of hydrophobic and 85% of GA-5 (4) modulators. All experiments were done in triplicate.

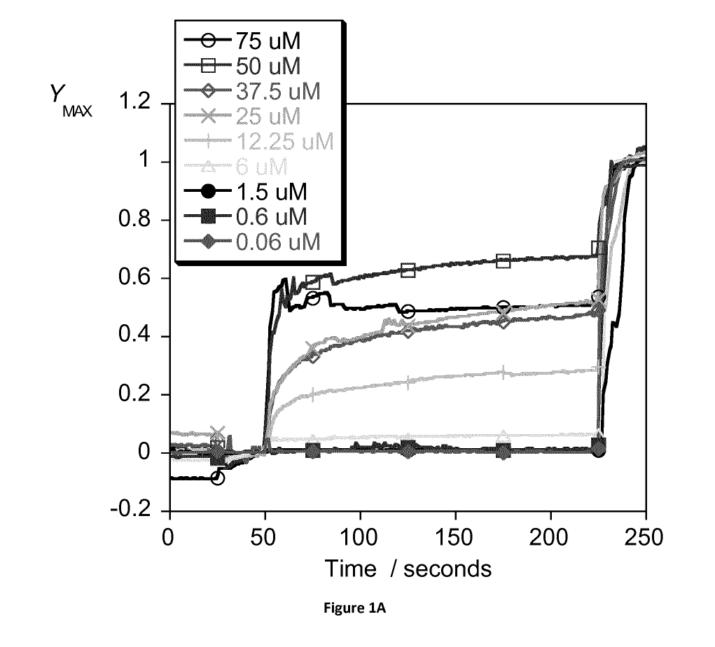

Fractional emission intensity I(t) (A) and dose-response curve (B) curves are shown in FIG. 1.

### Example 9: In Vitro Screening of siRNA Delivery with Amphiphilic Polymers

HeLa cells stably expressing enhanced green fluorescent protein (EGFP) were maintained in Dulbecco's Modified Eagle's Medium from Life Technologies™ (DMEM, high glucose, GlutaMAX™, pyruvate) supplemented with 10% (v/v) of fetal bovine serum (FBS) from Hyclone™ (Thermo Fisher Scientific Inc) and 500 μg·mL⁻¹ of Geneticin® (Life Technologies™). Transfection of HeLa-EGFP) was performed in the same medium, free of antibiotics. Cells incubations were performed in a water-jacketed 37° C./5% CO₂ incubator.

HeLa-EGFP cells were transfected either with Ambion® Silencer® GFP (EGFP) siRNA (siEGFP) from Life Technologies™ or scramble RNA (siMOCK, All Star Negative Control) from Qiagen. 72 h post siRNA transfection, cell supernatant was removed and EGFP expression was measured by fluorimetry (λₑₓ489 nm; λₑₘ 509 nm). The percentage of EGFP knockdown was calculated as the percentage of fluorescence decrease observed in cells transfected with siEGFP compared to transfection with siMOCK with the same reagents at the same conditions. Percentage of cell viability was calculated as the percentage of remaining fluorescence in samples transfected with siMOCK compared to non-transfected cells in DMEM, high glucose, GlutaMAX™ and pyruvate, supplemented with 0.125% (v/v) DMSO.

Lipofectamine® 2000 was used as a positive control of siRNA transfection in the in vitro screening of AMPHIPHILIC POLYMERs in HeLa-EGFP. The quality of the transfection experiments was assessed calculating the Z-factor using Equation S3,

$$Z \text{-} factor = 1 - \frac{3 ( {σ}_{p} + {σ}_{n} )}{\vert {μ}_{p} - {μ}_{n} \vert} \qquad Equation S3$$

with the mean and standard deviation of relative fluorescence units (RFU) of both the positive (p=cells transfected with mixture of siEGFP and amphiphilic polymers or Lipofectamine® 2000) and negative (n=non-transfected cells in medium supplemented with 0.125% (v/v) DMSO) controls (μₚ, σₚ, and μₙ, σₙ). Where μ is the average value and σ is the standard deviation. A Z-factor between 0.5 and 1.0 indicates an excellent assay, 0.5 is equivalent to a separation of 12 standard deviations between μₚ and μₙ.

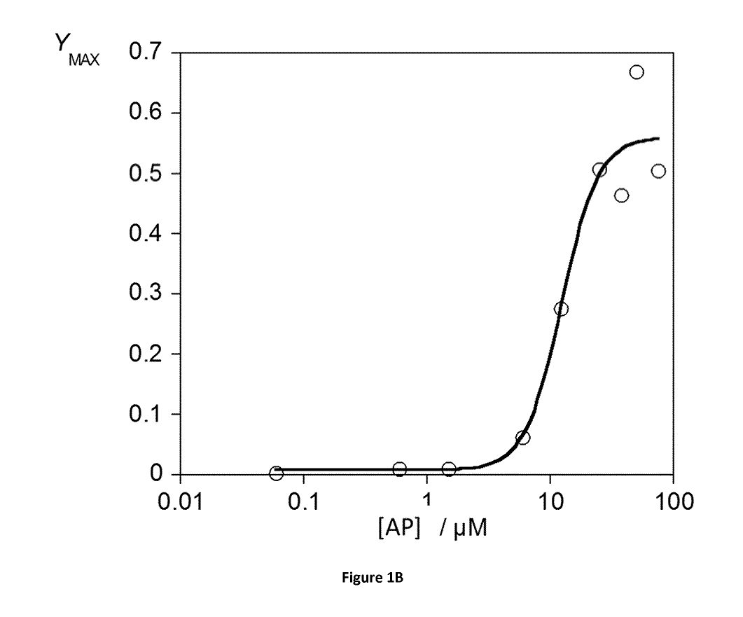

As shown in FIG. 2, the compositions of the present invention are as effective as Lipofectamine® 2000 but at concentrations 10 times smaller.

### Example 10: General Conditions for the In Vitro Screening of Amphiphilic Polymers in siRNA Delivery

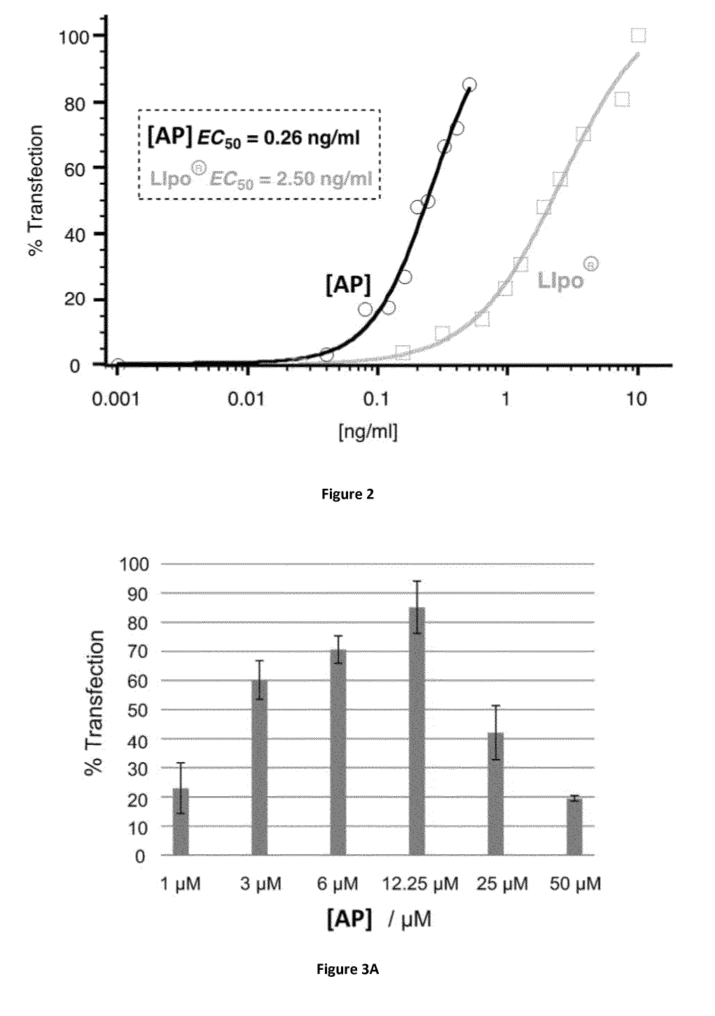

Stock solutions of freshly prepared amphiphilic polymers were prepared in DMSO/Buffer (v/v) as described above. The solutions of siRNA/amphiphilic polymers compositions were freshly prepared prior to the transfection experiments. 10 μl of the siRNA solution (1 μM in DMEM) and 8 μl of amphiphilic polymers solution in DMEM, high Glucose, GlutaMAX™, pyruvate, 10% (v/v) DMSO, supplemented with 10% (v/v) FBS, were added to 190 μl DMEM, high glucose, GlutaMAX™, pyruvate, supplemented with 10% (v/v) FBS and the mixture was homogenized by pipetting. Then, cell medium was aspirated from 96-well plate and 50 μl of the mixture was added in each well. The final concentration of DMSO in each well was 0.125% (v/v). All experiments were done in triplicate and the results are shown in FIG. 3.

### Example 11: General Conditions for the Evaluation of Cell Viability: MTT Assay

Cell viability of HeLa-EGFP cells was initially measured as the percentage of fluorescence decrease in samples transfected with siMOCK/AMPHIPHILIC POLYMER polyplexes compared to untreated cells in medium supplemented with 0.125% (v/v) DMSO. Results are shown in FIG. 4.

1. A polymer, salts and stereoisomers thereof, of formula (I) 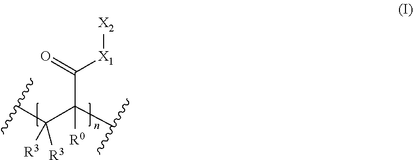
wherein
n is the average number of monomer units that is a number equal to or greater than 10;
R⁰ is selected from the group consisting of hydrogen, a C₁-C₃ alkyl group and CN;
each R³ is independently selected from the group consisting of hydrogen and a C₁-C₃ alkyl group;
X₁ is a group selected from the group consisting of —N(H)—, —O—, —N(H)-Alkyl- and —O-Alkyl-;
X₂ is independently selected in each unit from the group consisting of —NH₂, —N═C(H)R¹ and —N═C(H)R²; wherein R¹ is a lipophilic moiety and R² is a cationic moiety; and
wherein the percentage of lipophilic moieties present in the polymer with respect to the total number of X₂ groups is comprised between 1 and 99%;
wherein the percentage of cationic moieties present in the polymer with respect to the total number of X₂ groups is comprised between 1 and 99%; and
the sum of the percentage of lipophilic moieties and of the cationic moieties is comprised between 2 and 100%.

2. The polymer according to claim 1, wherein n is number comprised between 10 and 300.

3. The polymer according to claim 1, wherein X₁ is —N(H)—.

4. The polymer according to claim 1, wherein R¹ is selected from the group consisting of C₁-C₄₀ alkyl, C₂-C₄₀ alkenyl, C₂-C₄₀ alkynyl, C₃-C₄₀ cycloalkyl, C₄-C₄₀ cycloalkenyl, C₅-C₄₀ cycloalkynyl, C₆-C₄₀ aryl, C₇-C₄₀ alkylaryl, C₃-C₄₀ heterocyclyl and C₅-C₄₀ heteroaryl, optionally substituted with 1 to 10 groups selected from halogens such as fluoro or ether linkages.

5. The polymer according to claim 1, wherein R¹ is selected from the group consisting of C₁-C₁₀ alkyl, C₂-C₁₀ alkenyl, C₂-C₁₀ alkynyl, C₃-C₁₀ cycloalkyl, C₄-C₄₀ cycloalkenyl, C₅-C₁₀ cycloalkynyl, C₇-C₁₅ alkylaryl and C₅-C₁₅ heteroaryl, optionally substituted with 1 to 5 groups selected from halogens such as fluoro or ether linkages.

6. The polymer according to claim 1, wherein R¹ is selected from the group consisting of branched C₁-C₇ alkyl.

7. The polymer according to claim 1, wherein R² comprises a positively charged heteroatom.

8. The polymer according to claim 5, wherein R² comprises a cationic group having a pKa above 4 when protonated.

9. The polymer according to claim 5, wherein R² is a moiety of formula -L-G, wherein L is a linking group comprising an organic moiety, and G is a positively charged group.

10. The polymer according to claim 9, wherein the moiety of formula -L-G has the formula (XI) 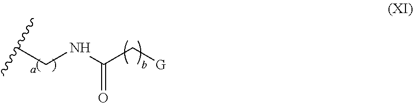
wherein a is number between 1 and 6; b is a number between 1 and 6; and G is a positively charged ammonium, phosphonium or guanidinium.

11. The polymer according to claim 1 wherein the percentage of lipophilic moieties present in the polymer with respect to the total number of X₂ groups is comprised between 5 and 70%, preferably between 7 and 60%, preferably between 7 and 20%, more preferably between 10 and 20%.

12. The polymer according to claim 1 wherein the percentage of cationic moieties present in the polymer with respect to the total number of X₂ groups is comprised between 10 and 99%, preferably between 40 and 95%, preferably between 60 and 90%, more preferably between 65 and 85%.

13. The polymer according to claim 1 wherein the sum of the percentage of lipophilic moieties and of the percentage of cationic moieties is comprised between 40 and 80%.

14. A composition comprising the polymer defined in claim 1 and a negatively charged compound.

15. The composition according to claim 18, wherein said negatively charged compound is a nucleic acid or poly(nucleotide).

16.-20. (canceled)

21. A pharmaceutical composition comprising the composition defined in claim 14.

22.-31. (canceled)

32. The polymer according to claim 1, wherein n is a number comprised between 10 and 300, X₁ is —N(H)—, X₂ is independently selected in each unit from the group consisting of —NH₂, —N═C(H)R¹ and —N═C(H)R², R¹ is a lipophilic moiety selected from the group consisting of C₁-C₁₀ alkyl, C₂-C₁₀ alkenyl, C₂-C₁₀ alkynyl, C₃-C₁₀ cycloalkyl, C₄-C₄₀ cycloalkenyl, C₅-C₁₀ cycloalkynyl, C₇-C₁₅ alkylaryl and C₅-C₁₅ heteroaryl, optionally substituted with 1 to 5 groups selected from halogens or ether linkages, and R² is a cationic moiety, and wherein the percentage of lipophilic moieties present in the polymer with respect to the total number of X₂ groups is comprised between 5 and 70%.

33. The polymer according to claim 1, wherein n is a number comprised between 10 and 300, X₁ is —N(H)—, X₂ is independently selected in each unit from the group consisting of —NH₂, —N═C(H)R¹ and —N═C(H)R², R¹ is a lipophilic moiety selected from the group consisting of C₁-C₁₀ alkyl, C₂-C₁₀ alkenyl, C₂-C₁₀ alkynyl, C₃-C₁₀ cycloalkyl, C₄-C₄₀ cycloalkenyl, C₅-C₁₀ cycloalkynyl, C₇-C₁₅ alkylaryl and C₅-C₁₅ heteroaryl, optionally substituted with 1 to 5 groups selected from halogens or ether linkages and R² is a cationic moiety, and wherein the sum of the percentage of lipophilic moieties and of the percentage of cationic moieties is comprised between 40 and 80%.

34. The polymer according to claim 1 of formula (VIIa) 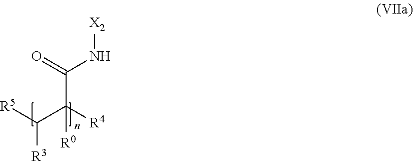
wherein n is the average number of monomer units comprised between 10 and 70;
R⁰ is hydrogen or methyl; R³ is hydrogen or methyl; R⁴ is selected from the group consisting of —SH, —S-Alkyl, —O-Alkyl, —OH, —NH₂; R⁵ is a C₂-C₁₂ alkylcarboxyacid or a C₂-C₁₂ alkylcarboxyacid derivative; X₁ is —N(H)—; X₂ is independently selected in each unit from the group consisting of —NH₂, —N═C(H)R¹ and —N═C(H)R²; wherein R¹ is a lipophilic moiety and R² is a cationic moiety; and
wherein the percentage of lipophilic moieties present in the polymer with respect to the total number of X₂ groups is comprised between 5 and 30%;
wherein the percentage of cationic moieties present in the polymer with respect to the total number of X₂ groups is comprised between 60 and 90%; and
wherein the sum of the percentage of lipophilic moieties and of the cationic moieties is comprised between 5 and 95%.

35. The polymer according to claim 1 of formula 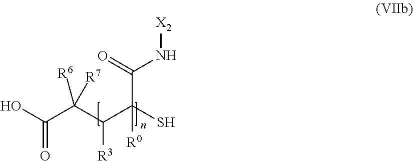
wherein n is the average number of monomer units comprised between 10 and 70; R⁰ is hydrogen or methyl; R³ is hydrogen or methyl; R⁶ and R⁷ are independently selected from hydrogen and a C₁-C₃ alkyl; X₁ is —N(H)—; X₂ is independently selected in each unit from the group consisting of —NH₂, —N═C(H)R¹ and —N═C(H)R²; wherein R¹ is a lipophilic moiety and R² is a cationic moiety; and
wherein the percentage of lipophilic moieties present in the polymer with respect to the total number of X₂ groups is comprised between 5 and 30%;
wherein the percentage of cationic moieties present in the polymer with respect to the total number of X₂ groups is comprised between 60 and 90%; and
wherein the sum of the percentage of lipophilic moieties and of the cationic moieties is comprised between 5 and 95%.
